(19) United States
(12) Patent Application Publication
(10) Pub. No.: US 2008/0319808 A1
(43) Pub. Date: Dec. 25, 2008

(54) Travel Monitoring

(76) Inventors: Victoria A. Wofford, New York, NY (US); Ashton R. Adams, Highlands Ranch, CO (US)

Correspondence Address: David M. Ostfeld;Adans and Reese, 4400 One Houston Center, 1221 McKinney, Houston, TX, 77010, US

(21) Appl. No.: 10/582,412

(22) PCT Filed: Feb. 16, 2005
(86) PCT No.: PCT/US2005/004950

§ 371 Date: May 30, 2008

Related U.S. Application Data
(60) Provisional application No. 60/545,023, filed on Feb. 17, 2004.
(60) Provisional application No. 60/599,537, filed on Aug. 6, 2004.

(51) Int. Cl. G06Q 10/00; G06Q 40/00; G06Q 90/00; G01C 21/34

(52) U.S. Cl. 705/6; 705/5; 705/30

(57) ABSTRACT

A Corporate Travel Management & Cost Consolidation system where each member of the Corporation's Travel Management Team, Corporate Executives and each Corporate Traveler uses a single terminal to view, and analyze Travel and Credit Card information from and to conduct travel and card transactions with two or more GDS, Travel Agency and by Credit Card Companies or other comparable ATDSs, alone or in combination with one or more types of electronic travel and card data. Travel and Credit Card information and processes the transactions are placed into a single integrated format. TravelMaster aggregates travel-booking information from each and every GDS, Travel Agency, and Credit Card Company or other vendors utilized by the corporation, including security, PNR identification, and pricing information. Booked travel and ask prices from participating GDS, Travel Agency, and Credit Card Companies may be integrated into the display. The combined information is displayed to a customer with standard views then sorted by price, volume, and other available attributes as desired by the customer. Each client is forwarded travel and card booking and payment information from only those GDSs, Travel Agencies, and Credit Card Companies that the customer is contracted with and thus entitled to receive.

### CROSS-REFERENCES TO RELATED APPLICATIONS

This application claims priority to International Application No. PCT/US2005/004950 filed Feb. 16, 2005 which claims priority to U.S. Provisional Application No. 60/545,023 filed Feb. 17, 2004, by Victoria A. Wofford and Ashton R. Adams and entitled Travel Monitoring, and also U.S. Provisional Application No. 60/599,537 filed Aug. 6, 2004 by Victoria A. Wofford and Ashton R. Adams and entitled Travel Monitoring.

### FIELD OF THE INVENTION

The present invention relates to data management systems and more particularly to a travel and credit card data management system.

### BACKGROUND OF THE INVENTION

There are several common varieties of technical and data management solutions available in the corporate travel management arena. Most travel agencies deliver monthly reports to corporations who utilize their services. These reports are generally delivered as hard copy or sometimes in electronic spreadsheet (e.g., Excel) format. Data for a specific month is generally delivered pursuant to the end of that month. Most corporate card providers deliver monthly reports to corporations who utilize their services. These reports are generally delivered as hard copy or sometimes in electronic spreadsheet (e.g., Excel) format. Data for a specific month is generally delivered pursuant to the end of the month. This data is also sometimes available online, and in some cases, corporations can go online and create custom reports which will pull the data desired for a custom report—which for a specific month is generally delivered pursuant to the end of that month.

For further background, see information regarding Prior Art at:

| | |
|---|---|
| U.S. Pat. No. | 6,442,526 |
| Vance, et al. | Aug. 27, 2002 |

System for corporate travel planning and management

This is a system and method for processing travel data and travel receipts. Travel data, including travel segments, is received by the system. Receipts for the trip are also received from a credit card provider. The received credit card data and travel data are each converted into a predefined format. The converted information is compared to match information in the receipts and the travel data such as chain codes or dates of travel. A list of matching data is output, such as to use in preparing an expense report.

| | |
|---|---|
| U.S. Pat. No. | 6,023,679 |
| Acebo, et al. | Feb. 8, 2000 |

Pre- and post-ticketed travel reservation information management system

This includes methods and system for effecting the instantaneous data transmission to a locally operated computer system upon an occurrence in the computer reservation system (CRS). Specifically, a method for automatically generating pre-ticketed travel information is disclosed, in which booked reservation information and traveler information is automatically transmitted to a locally operated computer system as soon as the booking of the reservation is complete. When the reservation information included more that one travel transaction, such as an air transaction, a hotel transaction and a rental car transaction, the traveler and reservation information is stored in a manner to track common information between different travel transactions, such as sale information, rather than track individual travel transactions. Also, a method of automatically updating an existing customer profile in a locally operated computer system upon the detection of the update of the corresponding customer profile in a CRS is discussed.

| | |
|---|---|
| U.S. Pat. No. | 5,832,453 |
| O'Brien | Nov. 3, 1998 |

Computer system and method for determining a travel scheme minimizing travel costs for an organization

This is a computer system and a method for determining a travel scheme minimizing travel costs for an organization, where the organization expects to purchase travel trips for a plurality of travelers for a plurality of travel links. Each travel link comprises a travel origin and a travel destination, and is served by at least one of the carriers. The system comprises a data input device for receiving travel information relating to the carriers and the links, a data storage device for storing the travel information received by the data input device, a processor, and a data output device. From the travel information, the system constructs an objective function representing a travel cost to the organization to purchase travel trips for the plurality of travelers for the plurality of predetermined links, and a set of constraints comprising restrictions relating to the objective function. The constraints are applied to the objective function to determine a solution of the objective function that satisfies the constraints and that minimizes the travel costs of the organization, and a data output device then generates a report representative of the solution. The travel information comprises travel cost information for each link for each carrier serving the link, demand and supply information pertaining to a projected demand for each link and a projected supply for each carrier, and carrier goal information pertaining to any predetermined goal the organization may have with respect to any of the carriers.

| | |
|---|---|
| U.S. Pat. No. | 5,570,283 |
| Shoolery, et al. | Oct. 29, 1996 |

Corporate travel controller

This is a system for controlling travel primarily in a corporate environment that interconnects travelers, travel agents and airline CRSs so that a traveler can communicate with the CRS with a user friendly. GUI to obtain schedule information and transfer such to a travel agent, the travel agent can use the selected schedule information for ticketing and to assure the lowest cost while the entire trip information is stored locally for management control. The system includes multiple connects to the CRS to overcome data transfer limitations specific to airline CRSs.

| | |
|---|---|
| U.S. Pat. No. | 5,253,166 |
| Dettelbach, et al. | Oct. 12, 1993 |

Pre-ticket travel reservation record keeping system

A record keeping system communicates with an airline's customer reservation system and a corporate client database system. A dedicated queue within the customer reservation system is accessed daily by the record keeping system to download data comprising travel itineraries. A relational database control within the record keeping system organizes the pre-travel data for efficient use by a corporate client. The reorganized data thus downloaded and organized is sent daily to the corporate clients for use in their own local database systems.

| | |
|---|---|
| U.S. Pat. No. | 4,862,357 |
| Ahlstrom, et al. | Aug. 29, 1989 |

Computer reservation system with means to rank travel itineraries chosen in terms of schedule/fare data

A remote database containing flight schedule, fare and fare limitations information is accessed from a local computer terminal. The information retrieved is sorted and scored in accordance with a predetermined travel policy stored in the local computer memory, and as applied to a proposed travel itinerary. A ranked list of applicable flights is merged into a single display.

It is an object of the present invention to provide a system for real time integrating, organizing, analyzing and displaying travel data, corporate card data and traveler profile information from one or more of the current Global Distributions Systems' (GDSs'), Travel Agencies' and Credit Card Companies' electronic data.

It is another object of the present invention to provide a means to translate the computer protocol of each GDS's, Travel Agency's and Credit Card Company's electronic data to a common protocol.

It is also an object of the present invention to provide on screen a real time display of the travel and credit cards information for each member of the participating travel program and of the electronic exchanges organized by the GDSs, Travel Agencies and Credit Card Companies.

It is further an object of the present invention to allow the aggregated Travel Agency, GDS and Credit Card information to be filtered through client driven specification and configuration parameters that provides maximum data granularity.

It is another object of the present invention to provide a system by which this aggregated data can be transmitted to the customer either through direct lines or the Internet or via any other form of network for display, management, reporting, interaction and execution.

It is also an object of the present invention to provide a Total Corporate Travel Management system where a single application on a single computer terminal can receive and manage data from any of the participating GDSs, Travel Agencies and Credit Card Companies.

It is an additional object of the present invention to allow a customer of the present system to take advantage of all the special data features of each GDS, Travel Agency and Credit Card Company, such as the ability to pass through direct commands or specify data execution parameters. As depicted in FIG. 37, the various data from the individual itineraries booked comes into the system from the GDS (37010), and the parser extracts the data from the PNR (37020). The system then runs commands in the open GDS system (37030) to verify and validate work done by the agency during the booking process, and audits whether the itinerary as booked by the agency actually complies with the parameters and policies specified by the corporation.

It is further an object of the invention to analyze the data from the various GDSs, Travel Agencies and Credit Card Companies to calculate real-time metrics and determine the occurrence of certain types of travel and card related events.

It is yet again an object of this invention to limit the information supplied from the GDSs, Travel Agencies and Credit Card Companies to a customer of the present invention to only those GDSs, Travel Agencies and Credit Card Companies where the customer is a client, member or electronic exchange user.

It is still another object of the invention to use the above-mentioned analytical capabilities to aid a customer of the present invention to make various business decisions, such as when and where to move market share.

### SUMMARY OF THE INVENTION

The present invention comprises a travel and credit card data management system whereby each system user as a single customer utilizes a single computer terminal to view and analyze real time corporate travel and credit card data for multiple business units and multiple travelers. The system consolidates data flowing electronically from multiple electronic data sources and multiple suppliers. The system is further utilized to communicate with all individual travelers, as well as any individual from multiple suppliers, and all management users at a specific client regarding travel issues, analysis of the travel spending, and contract/audit issues, simultaneously.

The consolidating computer system aggregates all electronic data from each data source, including corporate card providers, travel agency services suppliers, and ancillary travel services providers and presents the information in a variety of formats for instant analysis and complete end-to-end management of travel expenditures for the management team at the client company.

The system is designed to take data feeds from numerous disparate sources (e.g., multiple travel agency booking offices worldwide, online booking sources a corporation has contracted with, corporate card data sources worldwide, and feeds from other ancillary providers such as ground transportation companies, security specialists, travel benchmarking information, etc.) on a real time basis (as transactions occur). The system automatically completely integrates that data on a real time basis to provide comprehensive data analysis allowing corporations an unprecedented amount of control over their travel program. The system will also provide an unprecedented ability to track corporate travelers on the road, including tracking all deviations travelers make from their originally booked itineraries on a real time basis.

The system integrates all the data from all sources and presents it to the users in easily manipulated formats on their computer screens. This provides specific highlighting of travelers who have deviated from corporate policy, or travelers who have deviated from their planned itinerary. The system also highlights pricing errors on the part of the agency office, or on the part of suppliers where contract pricing is in place, thus providing a built in audit tool.

In addition, the system provides an automated travel budgeting tool for project and program managers within the corporation, which in addition to automating the budget planning process, immediately identifies to the travel management team any new destinations which require attention in pro-actively negotiating with needed travel suppliers servicing the new destinations.

The system also provides a comprehensive end-to-end management tool for all aspects of the corporate travel program including: pre-travel approvals, policy exception approvals, comprehensive integration of data from all sources on a global basis, real-time tracking of all travelers and all expenditures (including features especially designed for corporate directors of security), performance measurement and analysis relative to the corporation's current travel supplier contracts, as well as highlighting potential opportunities to negotiate with travel suppliers not yet a part of the corporation's travel program, and post-travel T&E accounting and expense reporting.

Further, said system provides audit capabilities of all negotiated rates with travel suppliers (i.e., confirming that travelers are paying the proper rates, and highlighting errors in rates charged by travel suppliers versus. negotiated contracts), as well as audit capabilities of the work being done by travel agency personnel and others involved during the process of completion of travel.

The computer system additionally presents to each traveler their individual information and any ancillary information required for the specific traveler to complete their travel, analyze their personal travel spending, benchmark that cost against other travelers at the same or different corporate levels, and reconcile all travel expenses.

The terminals, each participating computer, and each participating GDS, Travel Agency and Credit Card Company form a computer network. The GDSs, Travel Agencies and Credit Card Companies, in actuality, are each complex systems comprising a number of computers and networks. The system aggregates travel and card book information from each participating ECN travel and card book computer including security, travel and card identification, and travel and credit card price data. The combined data is displayed to customers separately and/or integrated for travel and credit cards, and sorted by price, volume and other available attributes as desired by the customer.

The system forwards to each terminal data from only those GDSs, Travel Agencies and Credit Card Companies of which the customer is a member or electronic exchange user and thus entitled to receive. The rights to the data may be based on the customer's arrangement or membership in GDSs, Travel Agencies and Credit Card Companies. Thus a customer may only be able to receive data from a subset of GDSs Travel Agencies and Credit Card Companies to which the client is connected.

As indicated above, once the data from a number of GDSs, Travel Agencies and Credit Card Companies are combined in the system, either the system or the terminal (or both) can be used to calculate real-time metrics. The real-time metrics, such as volume trends, price trends and various on demand calculations, can aid the client in making decisions. The system can also determine the occurrence of market events in which its customers may be interested, such as a new high travel for the day or a locked market where the best travel is equal to the best travel vendor.

The terminal displays the market data provided to it by the system and allows the customer to initiate travel and/or credit card transactions and route them through the system to any GDSs, Travel Agencies and Credit Card Companies for which the customer has permission. These transactions will be incorporated in the travel and credit card data distributed by the system. The terminal can also execute, book or cancel transactions against listed travel and credit cards by using the system to place the request using the correct protocol for the relevant GDSs, Travel Agencies and Credit Card Companies.

While the above discussion was in terms of GDSs, Travel Agencies and Credit Card Companies, it applies here and throughout not only to GDS, Travel Agencies and Credit Card Companies but Alternate Travel Data Sources (ATDSs) which generates the equivalent data. Equally, while there are a number of GDSs, Travel Agencies and Credit Card Companies, this application will use SABRE, Tri-Pen and American Express as examples throughout this document. The term traveler and customer are used throughout to designate any potential user of the present invention including travelers, travel managers, corporate card managers, executives, administrative and support staff, security directors, system administrators, and travel supplies.

### DESCRIPTION OF THE DRAWINGS

For further understanding of the nature and objects of the present invention, reference should be had to the following figures in which like parts are given like reference numerals and wherein:

FIG. 1 is a diagrammatic chart of the invention and how the invention works from a high-level process flow and architecture prospective;

FIG. 2 is a diagrammatic chart representing the typical service lifecycle of the invention;

FIG. 3 is a diagrammatic chart of global data sources referenced in this application and how they feed into the invention;

FIG. 4 is a diagrammatic chart of the parsing technology that is used to process the incoming disparate travel, agency and card data;

FIG. 5 is a diagrammatic chart of the general process and workflow of how the data is taken into the invention after the parsing is complete;

FIG. 6 is a diagrammatic chart of strategic travel management infrastructure that the invention enables clients to deploy and achieve while in use;

FIG. 7 is a diagrammatic chart showing the open architecture of the invention;

FIG. 8 is a diagrammatic chart of the legacy connection process which the invention uses to connect to other systems to supplement or fulfill additional operational data requirements;

FIG. 9 is a diagrammatic chart representing the four levels of travel management maturity and how the invention enables users of the invention to achieve greater success and travel program management maturity;

FIG. 10 is a diagrammatic presentation of the typical types of users that will use the invention;

FIG. 11 is a representation of a typical screen of the present invention showing features and functionality that a Travel Manager would use;

FIG. 12 is a representation of a typical screen of the present invention showing integrated travel and card data and how this integrated data can be used to identify changes travelers make while en-route;

FIG. 13 is a representation of a typical screen of the present invention showing airline management interface with accumulated booking, travel and card data;

FIG. 14 is a representation of a typical screen of the present invention showing a summary of all pending or approved travel related spending for both travel and corporate cards in a single interface;

FIG. 15 is a representation of a typical screen of the present invention showing how companies using the integrated data can identify policy exceptions before they happen and facilitate the approval process;

FIG. 16 is a representation of a typical screen of the present invention showing the expense reporting module, which displays integrated data from all travel and card sources at a summary level;

FIG. 17 is a representation of a typical screen of the present invention showing the expense reporting module, which displays integrated data from all travel and card sources at a detailed level by month and highlights which is card data or other categories;

FIG. 18 is a representation of a typical screen of the present invention showing the main reports screen, which allows a user to choose and create reports for integrated and separate data analysis;

FIG. 19 is a representation of a typical screen of the present invention showing a typical corporate card management interface, which displays all cards and card types utilized;

FIG. 20 is a representation of a typical screen of the present invention showing a performance overview for a corporate card account (e.g., AMEX), which shows how the card is performing against goals based on current card and travel booking data with card utilization;

FIG. 21 is a representation of a typical screen of the present invention showing detailed reports outlining total card spending against travel spending;

FIG. 22 is a representation of a typical screen of the present invention showing a detailed breakdown of an individual traveler's corporate card spending related to travel;

FIG. 23 is a representation of a typical screen of the present invention showing a typical report screen, which shows the various standard and customized reports based on card data;

FIG. 24 is a representation of a typical screen of the present invention showing the management console;

FIG. 25 is a representation of a typical screen of the present invention showing how the integrated data can be used by a security director within a company;

FIG. 26 is a representation of a typical screen of the present invention showing how a company executive would view the integrated data;

FIG. 27 is a representation of a typical screen of the present invention showing how a traveler would access and view data related to travel and credit cards;

FIG. 28 is a representation of a typical screen of the present invention showing the TravelCommander™ module that facilitates instant communication and information transfer for card and travel data;

FIG. 29 is a diagrammatic chart showing the general process and workflow of the data handler as data comes into the system from the various data sources, such as GDS data, Travel Agency Data and Corporate Card data;

FIG. 30 is a diagrammatic chart showing the general process and workflow of the permissions management system, including the Security, Authentication and Permissions Manager Systems.

FIG. 31 is a diagrammatic chart showing the general process and workflow of the Logging and Writer Systems;

FIG. 32 is a diagrammatic chart showing the general process and workflow of the Notification and Message Delivery Systems;

FIG. 33 is a diagrammatic chart showing the general process and workflow of the Reports System;

FIG. 34 is a representation of the user screen for the automated Travel Supplier Negotiating System, which is built into the system;

FIG. 35 is a diagrammatic chart showing the install, purchasing license, features manager and billing process;

FIG. 36 is a diagrammatic chart showing a high level overview of the database diagram and how data is imported into the system and flows into the database;

FIG. 37 is a diagrammatic chart showing the general process and workflow of the Pass Through of Direct Commands Within GDS;

FIG. 38 is a diagrammatic chart showing the general process and workflow of the Import System, Process System, and XML Extension Systems;

FIG. 39 is a diagrammatic chart showing the general process and workflow of the Layout Manager component of the system;

FIG. 40 is a diagrammatic chart showing the general process and workflow of the License Manager that validates rights and permissions of the client users of the system;

FIG. 41 is a diagrammatic chart showing the structure of the Plug-in Manager;

FIG. 42 is a diagrammatic chart showing the general process and workflow of the Pre-Travel Approval and Exceptions components of the system; and

FIG. 43 is a diagrammatic chart showing the results of the system, both in cost management of the travel process and the savings and productivity benefits resulting from the use of the system.

### DETAILED DESCRIPTION OF THE PREFERRED EMBODIMENTS

### Key System Components of the Invention

### Travel Data Processor

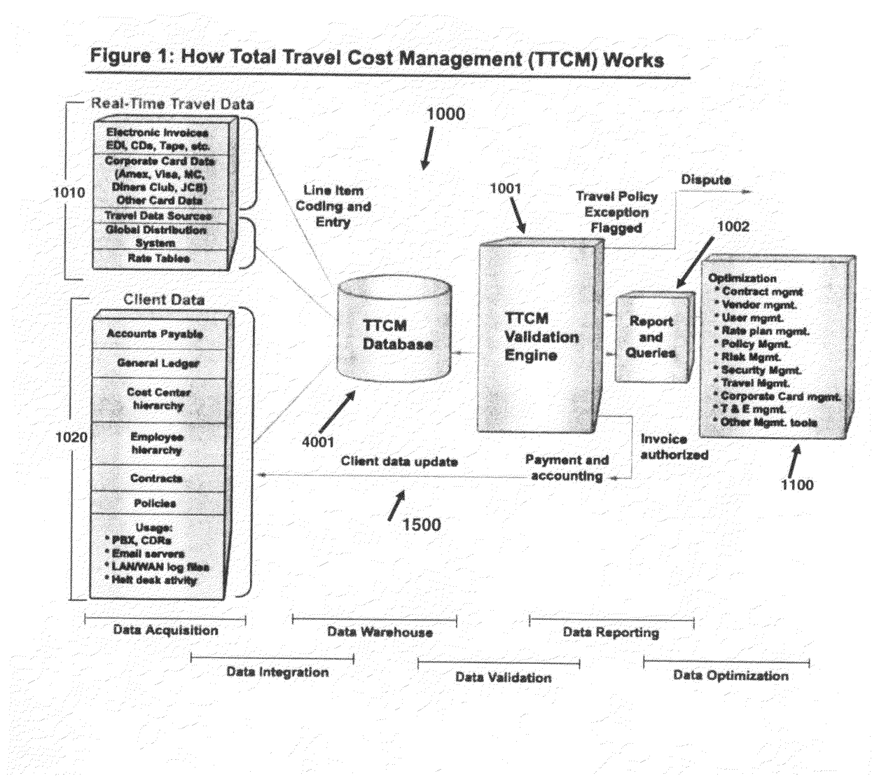

The Travel Data Processor System (1000) (FIG. 1) encapsulates all the functionality related to travel bookings data and corporate card data manipulation from all source feeds (3010, 3020), including real time travel data and client data. It is capable to translate, using the system's parsing engine (4001), any kind of file to an internal format and it also has the ability to export files with internal data to the other system modules (38030), especially the In-house Connector System (1500)—the only way to deal with existent legacy systems. The module has a plug-in interface (41010) for heterogeneous data formats.

The entire system has complete flexibility and scalability. The three main subcomponents (Import Mechanism 29100, Processing Mechanism 29200 and XML Mechanism 29300) give the architecture the desired interoperability to the other components of the system.

### Processing System

The processing system component (29200) processes data for the system, and the information will be refined. Further, the processing system component is EDI compliant and XML (SIMS format) compliant (8004, 8005). In addition, the component provides vendor-dependent implementations. All storage operations are intermediated by the Data Handler (4020) component as the only database access point. The use of a single database access point makes the module easily traceable and allows the administrator to create system run reports (1002).

### Import System

The import system component (29100) handles the input sources for invoices or other system required information and manages the data load process by taking advantages of processing system capabilities. It has multiple data sources (FILE, FTP, HTTP locations) and is easily extendable for another data source such as EMAIL, dependent upon customer needs.

### XML Extension System

This XML Extension System component (29300) serves as double-way access point by allowing the export of the information in XML format or the import of the information from a standard XML format. It provides the system with an XML interface, makes the system powerful by using standards, and creates the capability of interoperability with legacy or third party systems.

### Security Manager

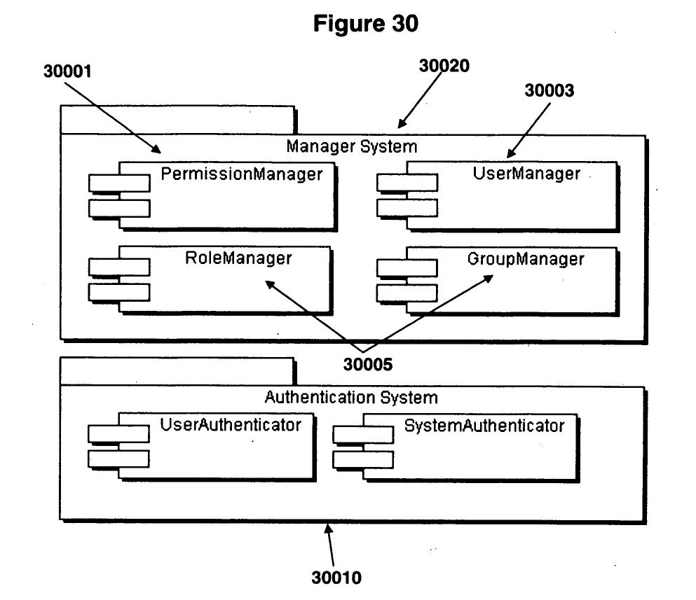

The base item for the security monitor (see FIG. 30) is the permissions (30001). A set of permissions would be aggregated in a well-defined role (30005). System users may be entities as parts of groups and roles (30005). The application filters the requests on a permission basis. Each action of the system has a code assigned and the permission will be the counterpart of a well-defined action.

The most important part of the module is the authentication mechanism (30010) that provides an easy way to authenticate users or modules within the architecture.

### Manager System

The manager system component (30020) provides mechanisms to manage permissions (30001) and aggregates permissions into roles (30005). It also creates users and assigns users (30003) in groups and roles.

### Authentication System

This authentication system component (30010) provides an easier way to authenticate users into the system because it has the capability to enable/disable access to a specified action.

### Log System

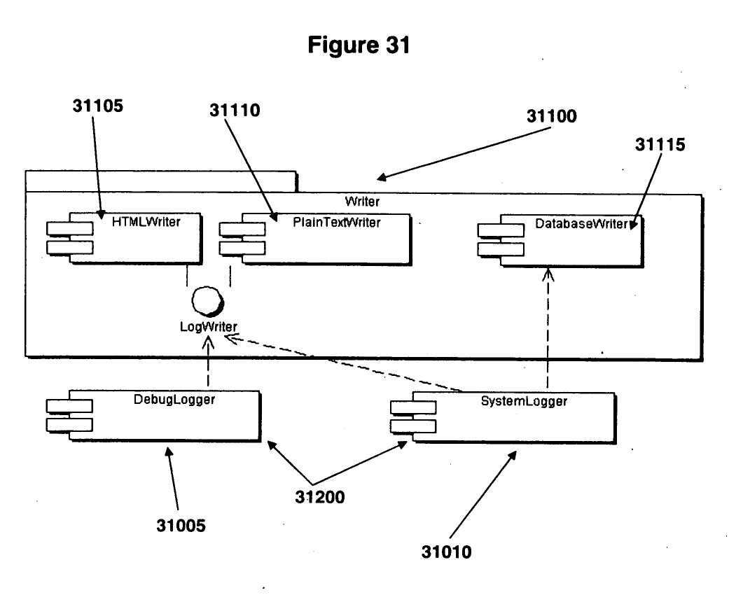

As depicted in FIG. 31, the log system has two components (31005, 31010). There is some key information, except the application data, that have to be stored while an application is running. There are two main categories of events: debugging events and tracing events. The debugging information (31005) is used just for text display purposes and is useful for system maintenance. The tracing information (31010) is used for administration purposes, giving an administrator/supervisor the chance to inspect the steps taken by the users while using the system. It is also useful for management purposes by providing time and action information regarding specialized staff.

### Writer

The writer component (31100) does the write actions. It supplies the basic target implementations such as Plaintext (31110) and HTML (31105). Database Writer provides the accessibility to a relational database storage support (31115). In this manner it provides the reporting system with information for dynamic reports and analysis.

### Logger

The logger component (31200) is made up from a debugger (31005) and a system logger (31010). The debugger stores information for debugging purposes usually in plain text format or HTML. However, PDF or XML formats can be added easily. The system logger (tracer) controls the logging process and messages (multi-language support) for administrative purposes rather than maintenance or debugging.

### Notification System

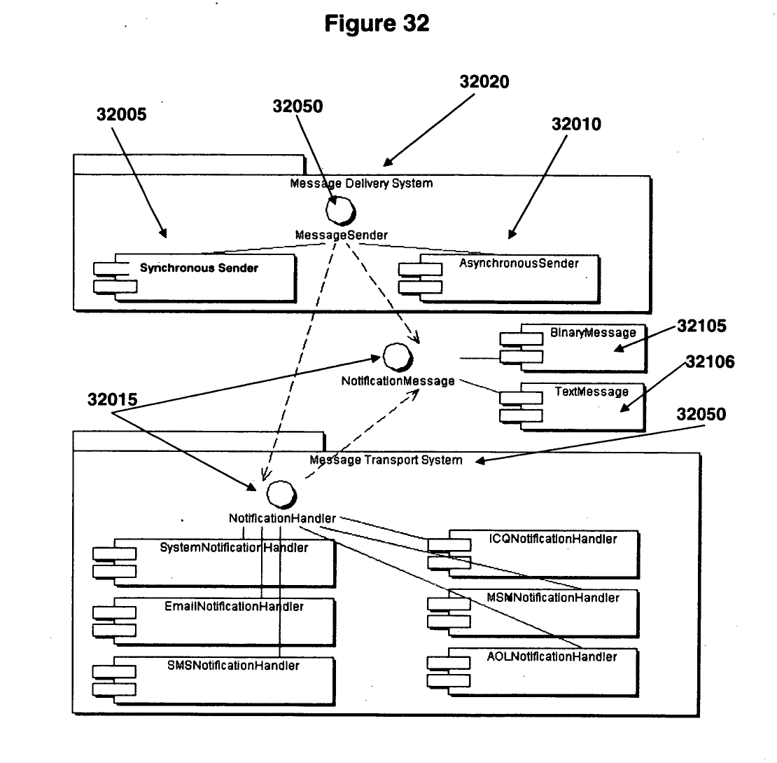

FIG. 32 depicts the general workflow and process of the notification engine, which is made up by two main components, a synchronous component (32005) and an asynchronous component (32010). The synchronous messenger server is used for real time communication and the asynchronous messenger is designed especially for automatic notifications or e-mail. The second mode does not involve occupied waiting while communicating and is the most suitable in a distributed environment.

It creates an interface for classic messengers and e-mail. Messages can be of two types, text and binary, and the targets can be heterogeneous (i.e., different type of messengers and e-mail of directory location destinations).

### Notification Message

The notification message component (32015) provides two types of messages, text (32106) and binary as (32105) discussed above. The other modules can take advantages of this architecture by sending plain text messages or HTML, PDF, SVG or XML messages.

### Message Delivery System

The message delivery system component (32020) provides the notification mechanisms in two ways, synchronous (32005) and asynchronous (32010).

### Message Transport System

The message transportation system component (32050) provides the transport mechanisms for various types of destinations. It can notify the system with messages usually used to be displayed as banners or general interest information. It provides implementation for e-mail SMS notifications and integrates with most used messengers such as ICQ, AOL, MSN Messenger, Netscape, Yahoo and others.

### Default & Custom Reports System

The most important part of an application that manages data integration information is the reporting component (33100). The “display data” is a sensible problem in every application. Taking advantages of Velocity, XML, XSL, XSL-FO and SVG is a key part of the entire architecture of this component. It is all about informing the user about what it is interested in—cost savings, cost migrations, cost estimations, travel bookings, tracking of travelers on the road, policy violations, traveler security, etc. Finally, graphic reporting gives the user a more accurate picture of the process because it puts the designated people in connection with the rhythm of the business itself.

Built-in reports (33050) are the default reports, while dynamic reports (33010) are customizable reports based on user search criteria and different output formats. They pull information changes based on users' inputs; thus, different output formats (storage purposes) can be generated.

### Workflow Manager

The Workflow Manager module (5000) holds all the actions and aggregates them as items into a graph. The mathematical model of the module is the state machine. The workflow controller (5010) manages the user steps while working with the application. This is the guide of a well-defined process, this role being to control the input and dispatch the action request. For example, if a user logged in from a web browser and went to some pages, it cannot get back to the previous page by pressing the “back” button into the browser; the only way to get back is to redo the process, if data was processed and closed. The user cannot get back to the original page, modify key values, and do different actions to the same data. This prevents unpredictable behavior to happen into web applications.

### Layout Manager

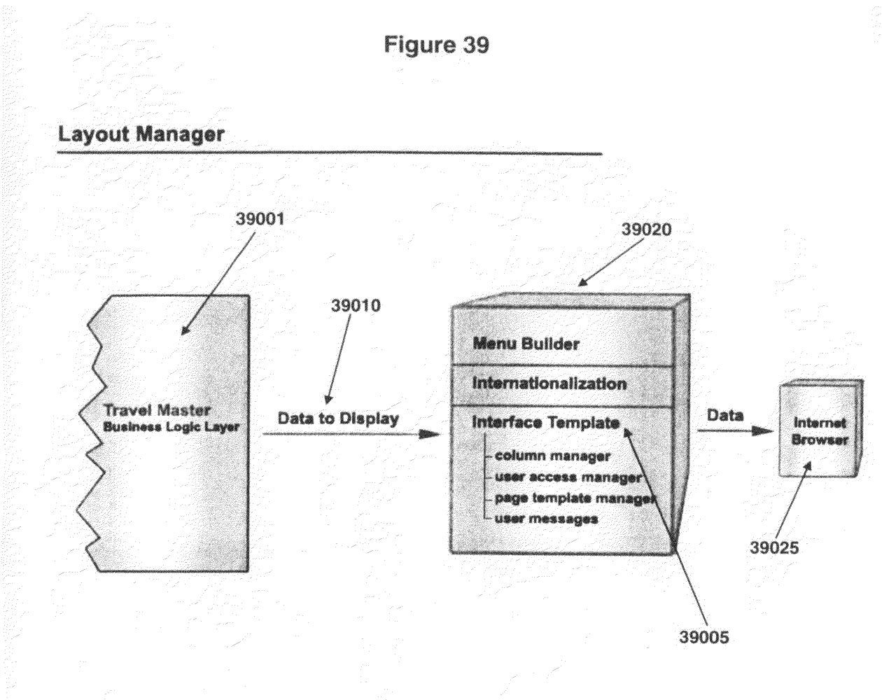

The entire interface of the application is based on skins. FIG. 39 depicts the layout manager. The layout manager takes advantages of Velocity scripting language (39010) to bring the data into the interface (39001 & 39010) to implement that. This permits easy customization of the interface and GUI personalization (39020). The system is easily extensible, just by rewriting the interface generator templates (39005) as a replacement for the entire application or just for a part of it. What creates advantages for an application structured that way is the speed of the interface generation process and the availability to generate the same content (39025) even if the application server that hosts the component is not running. That means the application can easily render the same content without using JSPs or other technologies that depend on the running status of the server.

### Plug-In Manager

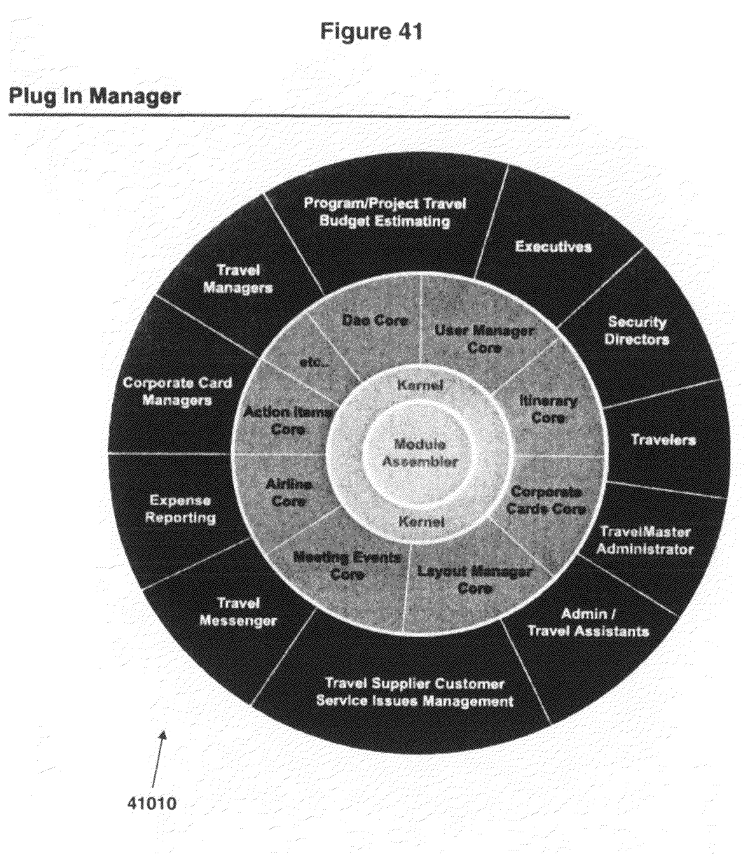

Some components of the distributed application can work alone, and others request the presence of some implemented modules. A customized module, a new feature module, represents these kind of components that have to be manipulated by a manager as depicted in FIG. 41, and all these components (41010) are named “plug-ins” because they support a well defined connectivity interface and permit runtime activation and passivity or even uninstall.

### In-House Connector

Many organizations have already implemented some software systems like accounting stock or applications. Because these “legacy systems” are usually written in programming languages other than Java or even if they are in Java it is a 90% probability to not be conforming to Java Connector API specification. There is a necessity to have interoperability between the present system and legacy systems. This is done by a special state-of-the-art system called an In-house Connector (1500) that gives organizations a chance to integrate with existing management software.

### License Manager

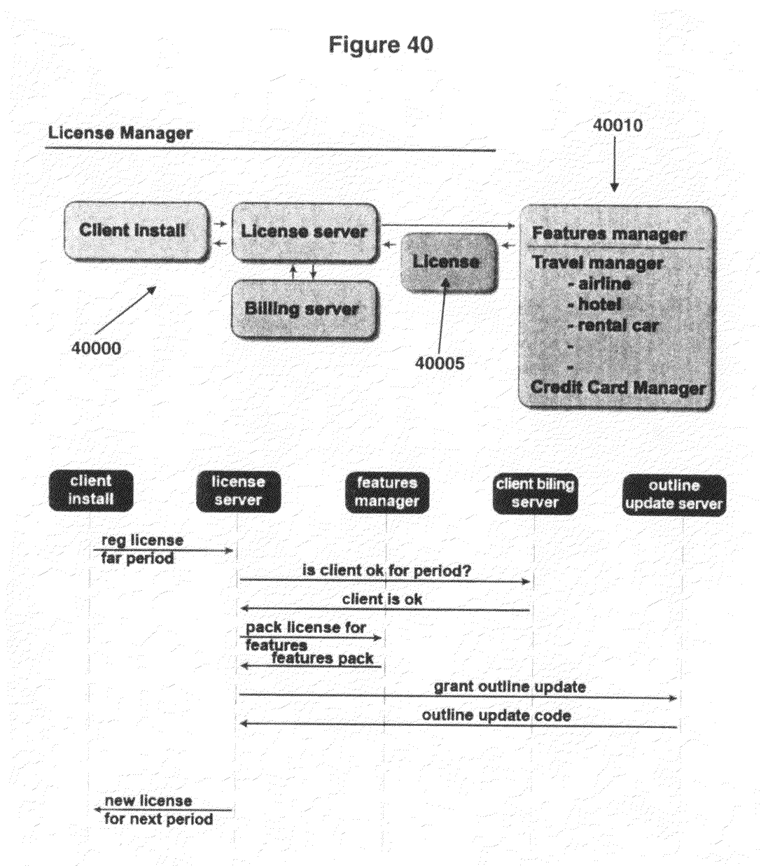

Every customer support department treats the clients on a license code basis. Treating the customers by their license number improves the business by speeding up the communication and identification process. Also the license management system as depicted in FIG. 40 encapsulates the identification functionality (40005) and opens or restricts some key system features (40010).

Previously no application has been built which integrates travel data and corporate card data on an itinerary-by-itinerary basis, highlighting specific data which is critical to the maintenance of a well run, highly controlled travel program—as well as improving negotiating leverage with travel suppliers.

For instance, prior to the invention, a travel manager might have travel bookings data indicating that 100 room nights had been booked through the travel agency office at a specific hotel property. Further the corporate credit card data available to the travel manager might indicate that 105 room nights had been paid for at the same specific hotel property. However in speaking with the hotel, they might show that there had been only 38 room nights actually. Previously it would take a great deal of manual investigation to determine (if it were even possible to determine), what had occurred. (For instance one scenario in this situation might be that of the 100 room nights booked through the travel office 62 were cancelled, and those travelers never arrived at the hotel, while 67 other travelers all walked into the hotel unexpected and booked rooms without asking for the corporate rate). Other scenarios are possible as well.

Now, the travel manager will know automatically how many room nights booked through the travel office were actually utilized, how many were cancelled, how many travelers who did not book through the travel office actually stayed at the hotel and what rate they paid, and, at the touch of a button, will be able to provide the hotel with an automatically generated report which details the traveler's name, dates of arrival and departure at the hotel, invoice number, and total payment made to the hotel.

### Travel Data Processing and Integration

The travel data processing and integration function (1000) is the administrative mechanism that receives and maintains the data associated with the data feed from all travel booking sources and all corporate card data sources, as well as all ancillary travel services providers which may be extending data feeds to the company and/or to the system. Processing and integration will include both recurring and non-recurring expenses.

### Validation

The validation function (1001) of the system involves the identification of those variables that do not comply with expected travel terms and conditions. It is the validation function combined with the audit task that identifies and recoups funds associated with errors and exceptions. Audits also reconcile data with known vendors, users and contracts to assure enterprises that payments made for services comply with services rendered and corporate policies.

Audit functions include billing assurance, rating and faring assurance, compliance, accuracy, validation and reconciliation. Historically, as “audits” relate to travel-spending, companies have performed audits as a “clean-up” effort on an annual or semi-annual basis. If such audits have been performed at all, and if in travel, recovery of funds due to prior mis-charging errors has historically been near zero. However, the validation function (1001) of the system will do automatic dynamic audits on bookings on a real-time basis and flag any errors of any kind, allowing for correction prior to commencement of travel. As these dynamic audits rely on highly integrated processing systems, they have never been possible previous to recent technical development in the EDI field, and no product has ever been produced that performed such audits on a real-time basis as travel bookings occurred. By applying the present technology invention to the error problem, companies can process much more expense, corporate card and travel data more quickly today than via manual labor.

### Correction

The correction function 5005 is used when faring, rating or policy issues fail to comply with contract terms. The correction function of the system will flag the error and thereby alert the travel management group within the company to the situation prior to the commencement of travel thereby allowing for correction at the point of sale. Receiving travel credits or refunds after the commencement of travel is nearly impossible.

### Buy

Part of the difficulty in ascertaining travel spending and contract compliance has been because travel services are actually contracted first and paid for over a time period. Additionally, rates at airlines, hotels and rental car companies change with tremendous volatility—hourly or even by the minute in some cases, previously making the process of determining what rates should be charged under the contract nearly impossible for an individual at the company. As such, the typical “buy” step in the total cost management framework, as it relates to corporate travel, has historically been virtually impossible to determine on an individual trip-by-trip basis.

Within companies taking advantage of the present system's solution, there are generally three disbursement models for the buy function (2002) in which the actual payment of travel expenses occurs.
1. The cost of the various travel components is charged on a credit card as the employee travels, and when the employee has returned to their home base, the employee prepares a travel expense report for which the company then reimburses the employee.
2. The company and the travel services provider have shared access to a clearing account in which the company transfers the appropriate funds for disbursement by the travel services provider on their behalf.
3. The vendor sends the enterprise a single bill for its services, as well as the aggregate travel service bills. The vendor then pays directly on behalf of the enterprise. Therefore, part of the compelling need for the present system's solution is to make sure companies are only paying for what they should, before they make payment.

Part of the value-add that the system's solution provides is the integration of the invoice, corporate card and travel data they collect with A/P and the general ledger systems, so key financial data can be efficiently shared within the organization. The system's process makes appropriate accounting entries on travel spend details and even performs accruals and capital expense accounting.

### Chargeback

In this way, the system allows expenses to be associated within companies to the business unit, group, or unit that used the travel service. The present invention also enables travel expenses to be charged directly to a user through direct coding charges to cost centers or leveraging allocation tables to distribute spending across commonly assumed or actual usage levels.

### Analyze

With valid charges paid, travel managers and finance counterparts have provisions to understand the underlying trends and areas of improvement.

### Reporting

The system's solutions flag areas of action that will either improve service quality or lower the overall cost basis of the travel budget. The most effective reporting tools among the system's solutions are those that present a clear analysis that enables an actionable event. The system is flexible to permit this. Critical to that process is the prioritization of required actions. Reports that show estimated dollar impact make planning and sourcing decisions that much easier.

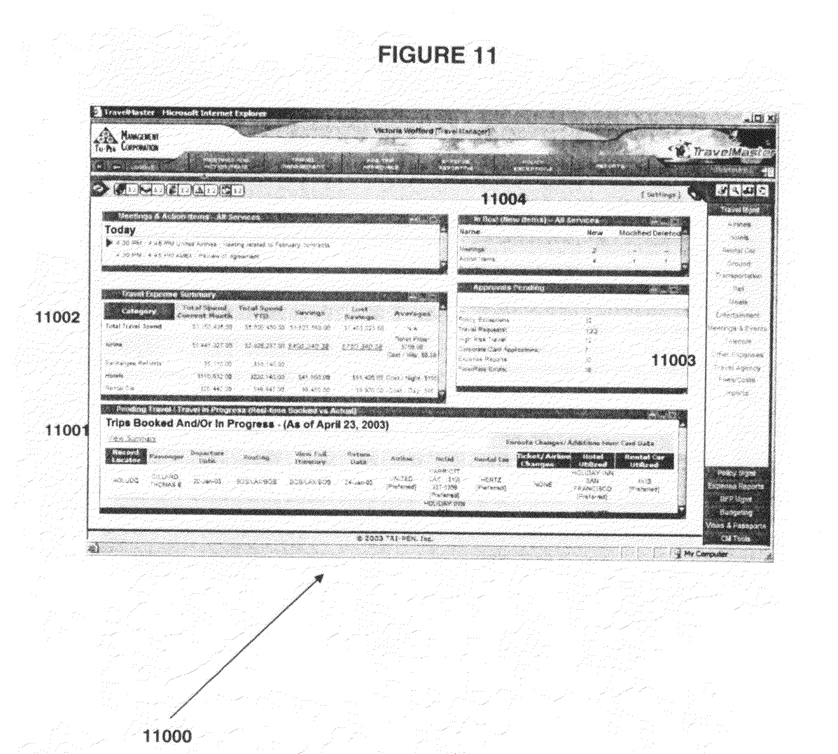

No other solution available to corporations today provides a reporting mechanism for enterprises to visualize and analyzes the complete aggregate travel spending and integrated corporate card data—across all services, vendors and business units—to allow simplified decision-making processes (36010). Whether the enterprise or the vendor hosts the system's solution, a web-based portal is utilized to access this data, making this invention highly flexible and presents the data in ways never before possible. This is due to the fact that, until the existence of the system it was not possible to integrate corporate card and travel data on both the micro and the macro levels simultaneously in real-time and display that data to a user along with complete simultaneous analysis. Examples of these types of interactions and analysis presented to the user along with the integrated data are depicted in FIGS. 11 through 27.

### TravelMaster Credit Cards

The invention provides “dashboard” views (19000) of key tables or charts on spending and usage or exceptions, standard reports on typical spending and usage patterns, customized reports for cross-tabulating particular spending areas or usage, and complete flexible ad hoc query capabilities.

### Planning (Proactive and Not Reactive)

Armed with the information set out above, enterprises can determine how best to influence necessary changes within their travel program. The present invention also automates parts of the optimization process. Optimization planning can impact several points in the travel service ecosystem.

### Travel Services Management

This component (11000) presents users the opportunity to consolidate underutilized services and take control of the procurement, implementation, and management of these travel services.

### Supplier/Vendor Management

This component (20000) presents users the opportunity to eliminate risk (e.g., via redundant carriers) and ensures contract compliance (20005) and enhanced communication between the organizations and their travel suppliers/vendors.

### Contract Management

This component (20005) presents users with information based on usage patterns and viewing contract terms that may need to be renegotiated, as well as compliance, negotiations, communication and interaction.

### User Management

Costs are driven down through proper user training (e.g., proper understanding of travel services, policies and options). This aspect of the invention (6005) allows companies to customize the environment in numerous ways, including incorporating the specific travel policies, supplier contracts and goals and providing automated alerts both to travelers as well as to the travel team of exceptions over or under production of supplier contract goals and other similar actions which all help the corporation to maximize productivity and policy adherence.

### Sourcing

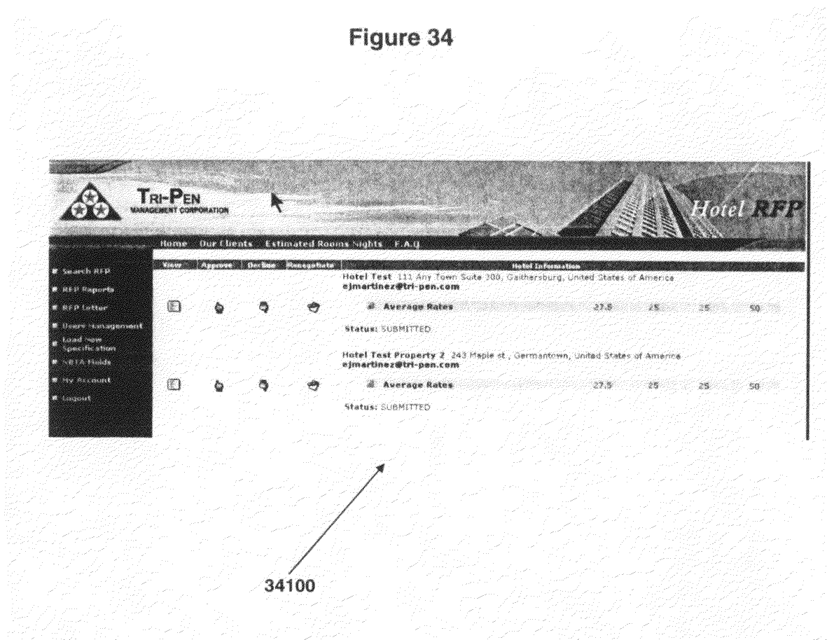

As most travel services are billed on a recurring basis, original contract and supplier decisions hold true over time, but new services and travel requests continually cycle through a dynamic demand process. The system allows the travel management team to immediately initiate new requests for negotiated pricing to travel suppliers through the invention's automated system and conduct complete negotiations with said suppliers online, as depicted in FIG. 34.

### Negotiations

With the built in data and information of common travel contract structures, pricing models, vendor pain points and SLAs requirements, enterprises can utilize the system's data to negotiate new travel vendor relationships when data in the system indicates that a specific supplier is gaining volume due to changing travel needs, the system automatically alerts the travel management team of the need to contact the supplier and negotiate a contract with a new supplier.

### Benchmarking

The invention maintains databases of key data sets—typical spending, usage, pricing and the like—that establish a norm among relevant peer groups. Enterprises can consult such benchmarking data to gain an understanding of how they compare to like-sized companies or similar vertical industries. Due to the aggregation and normalization of data across all clients, this benchmarking data can be aggregated and displayed in specific data columns in all of the data analysis screens so the travel management team can assess at a glance how their data varies from similar data across a wider body of corporations.

### Process of the Invention

### FIG. 1: How Total Travel Cost Management Works

FIG. 1 depicts in detail how the data from the GDSs, Travel Agencies, Corporate Cards, and other TDSs (1010) are fed into the system's parsing engine (4001) Simultaneously, it is processing client data feeds from multiple systems like AP/GL, policies and other legacy systems (1020). This data (1010, 1020) is parsed into a new standard data protocol formatted in XML, and then the pre-defined and/or client specific business rules (4200) are applied before the data is inserted into the system's database (7).

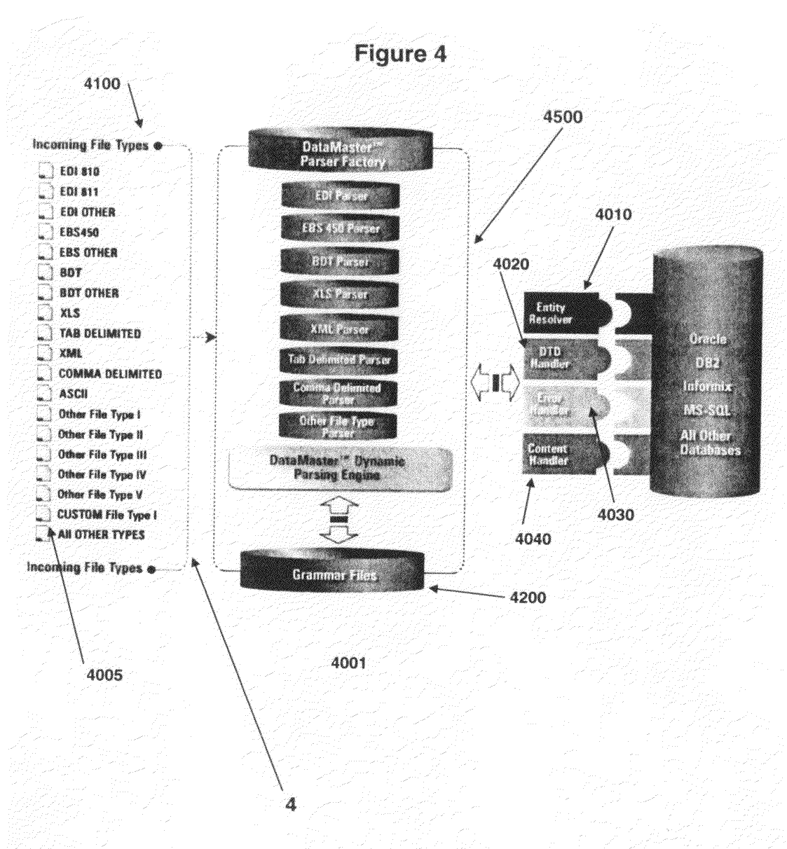

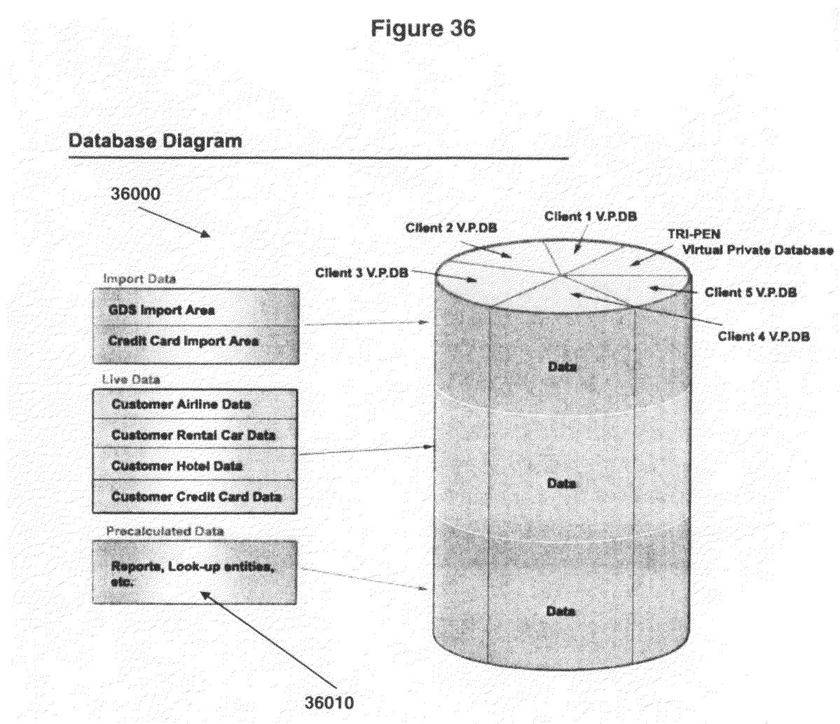

The parsing engine (4001) has a unique Entity Resolver (4010), DTD Handler (4020), Error Handler (4030) and Content Handler (4040) which verifies the data is in the appropriate XML structure and integrated protocol before database insertion (36000), (see FIG. 4 and FIG. 36).

FIG. 1 further shows how the data is also passed through a validation engine (1001) after the real time data base insertion (1010, 4001 and 4040) before data is sent to other systems (e.g., AP/GL, user interfaces, policy or other exceptions processing) (1020). It is also validated (1001) before sending to the reports engine (1002) and then on to the management functions (100) within the invention—Contract Management, Supplier Management, User management, Travel Management, etc.

The data is:
1. Captured in any electronic format available today (i.e., EDI, XML, XLS, EBS, Text, etc.) (4100);
2. Captured from any travel data and corporate card sources (i.e., GDS, Travel Agency, Credit Card Companies, and the like) (1010);
3. Parsed through the DataMaster dynamic parsing technology (4001);
4. Transformed into a common protocol and formatted in XML and integrated;
5. Validated (1001);
6. Presented to the user in various visual formats, interfaces or documents (1002);
7. Made available to manage, change and control (1100); and
8. Results in optimal travel management capabilities.

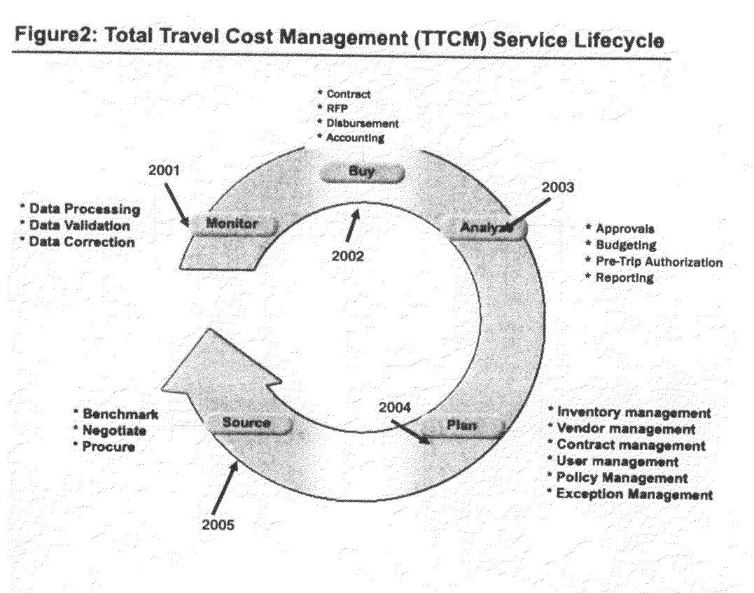

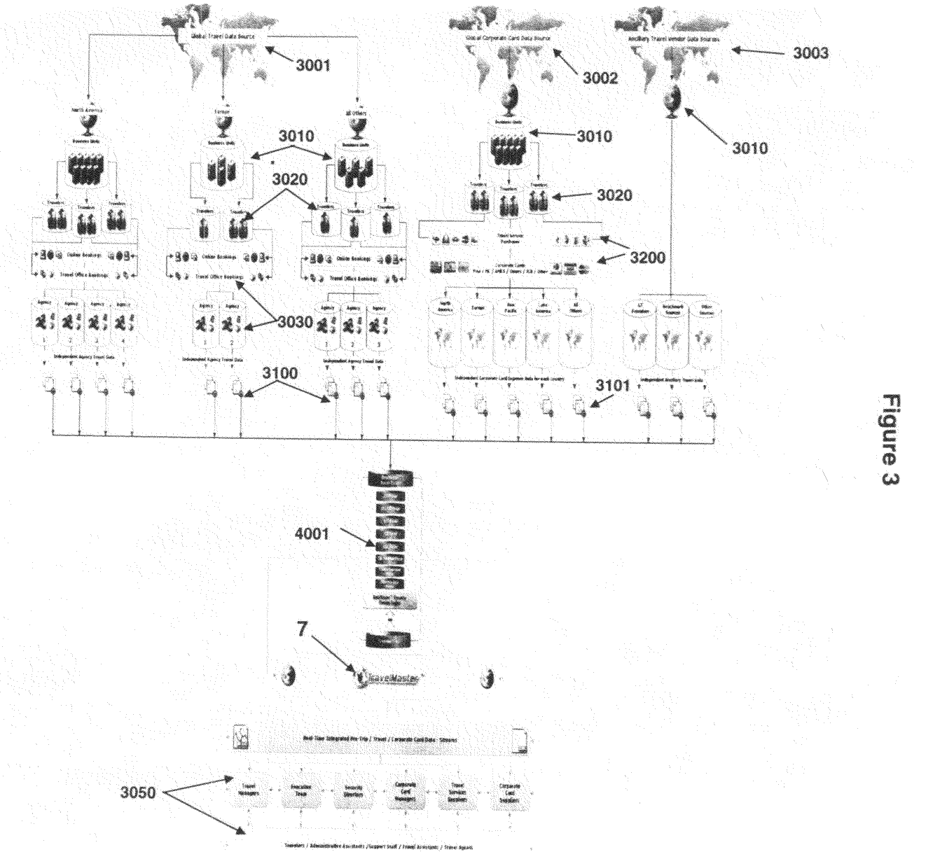

### FIG. 2: Total Travel Cost Management Service Lifecycle

FIG. 2 depicts the lifecycle related to the invention. The steps are:

1. Monitor Travel and Card Data (2001):
a. Data Processing
b. Data Validation
c. Data Correction

of data processed by the system's engine (4001)

2. Buy Travel Related Services (2002):
a. Accounting
b. Disbusement
c. RFP [not on drawing]
d. Contract [not on drawing]

through data processed by the system (2001)

3. Analyze Data and Performance (2003):
a. Reporting
b. Pre-Trip Authorization [not on drawing]
c. Budgeting [not on drawing]
d. Approvals [not on drawing]

4. Travel Management & Planning (2004) Based on Data and Performance of Step 3:
a. Vendor Management
b. Contract Management
c. Inventory Management
d. User Management
e. Policy Management
f. Exception Management
g. Other

5. Source Travel Services (2005) Based on Analysis of Step 4:
a. Benchmark
b. Negotiate
c. Procure

### FIG. 3: Data Sources

In each country, there are travel service providers (3001) who produce separate data, there are corporate card providers (3002) who produce separate data, and there are ancillary travel vendors (3003) who may service a company which produces separate data.

In each country where the company has facilities (3010), they may have one facility or multiple facilities. Each of these facilities houses travelers (3020), from one traveler (3020) to thousands of travelers (3020). Each of these travelers (3020), depending upon company policy, may be utilizing one or more travel agencies (3030) and one or more travel offices of each agency (3030) utilized. Each of these travel offices (3030) are producing data (3100), and travel data (3100) is consolidated by each individual agency (3030). However, each individual agency (3030) has separate data streams for each country.

Each of these travelers will also be carrying one or more corporate cards (3200) provided by separate corporate card companies (3020). Even when a company utilizes only a single corporate card across all travelers, the corporate card company produces separate data in each country, and the data streams are separate. If a company utilizes more than one corporate card, there are multiple data streams with corporate card data (3101) coming from each individual country.

Likewise, each individual traveler may be utilizing one or more ancillary travel vendors which are approved by the company, and each of these travel vendors is usually producing separate data for each individual country. The separate data streams will now all flow into the system' sparsing engine (4001), where the data will be matched and integrated and fed into the system's interface (7) on a real time basis where the data is ready to display to the various system users (3050) of the system within the company, allowing the company to, on a real time basis, achieve total travel cost management.

### FIG. 4: DataMaster—Dynamic Parsing Engine

FIG. 4 depicts the parsing engine (4001) which takes the travel, card and other travel related data from disperate sources (1010, 1020) and then parses it into an integrated common data protocol.

As describe earlier, the parser (4001) takes any incoming file type (4100) available today and runs it through its unique parsing engine (4500) of the parser (4001). The engine (4100) includes a data file type parsers (4500) driven by a database of grammar files (4200) that produce the language which allows the parser (4001) to understand what type is being entered into the system, and then parse it correctly, applying the appropriate rules (4200) and then sending it through data resolver (4010) and handlers (4020, 4030, 4040) before being validated.

Although the process seems simple, the output of the common integrated travel and card data in a common protocol formatted in XML is unique to this invention.

The system by this use may be kept platform and database independent.

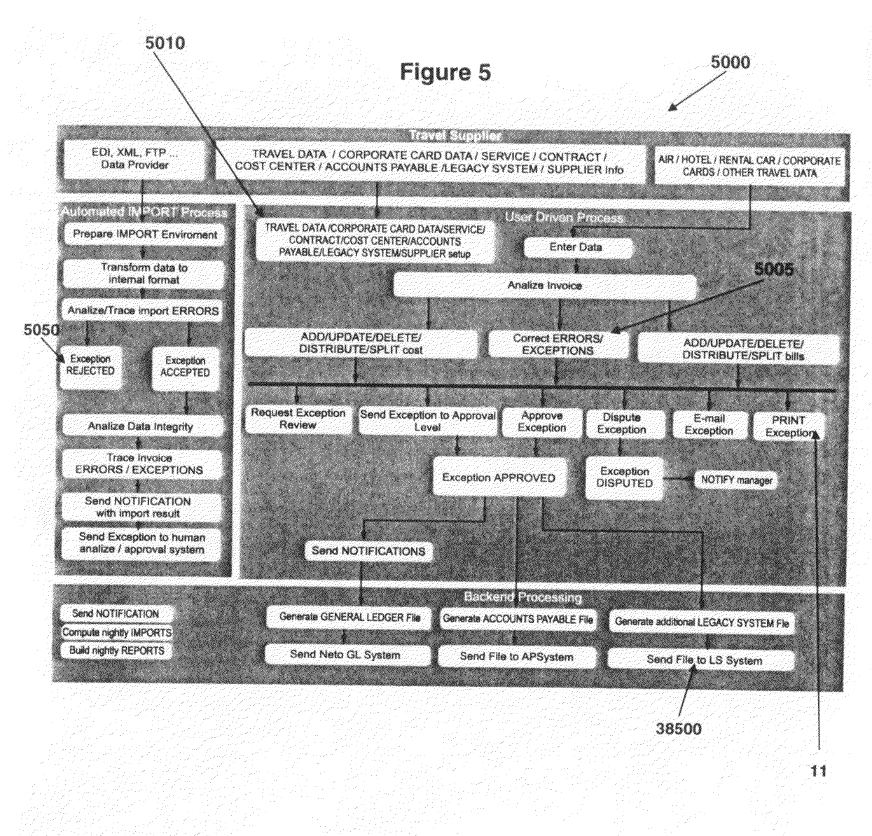

### FIG. 5: DataMaster—Workflow Diagram

FIG. 5 depicts an example of workflow that will be used in the invention. The diagram shows the receipt of the data and both automated and manual workflows that lead into the back-end processing.

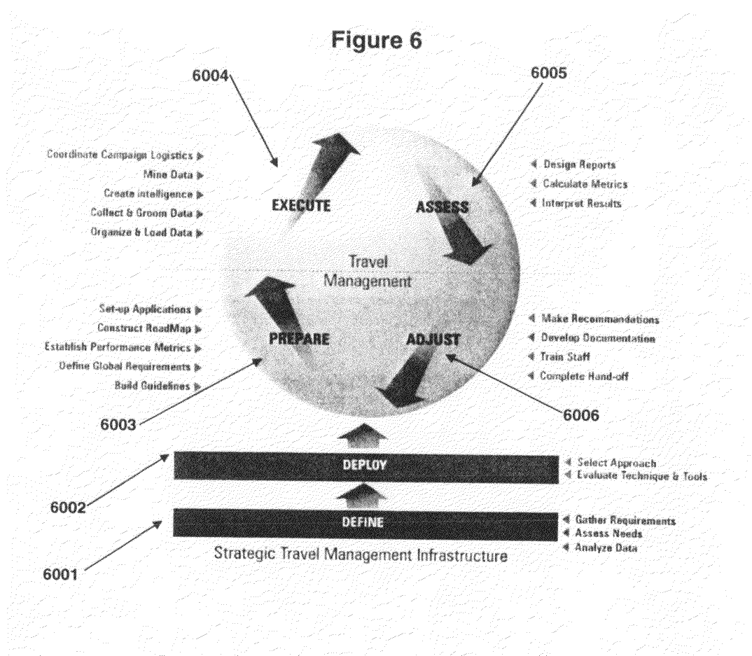

FIG. 6: DataMaster—Deploying the Invention

This diagram depicts the deployment of the invention that results in a Strategic Travel Management Infrastructure. The steps are:

1. Define (6001):
a. Gather Requirements
b. Assess Needs
c. Analyze Current Data

2. Deploy (6002):
a. Select Approach
b. Evaluate Techniques and Tools

3. Prepare (6003):
a. Setup Applications
b. Construct Roadmap
c. Establish Performance Matrix
d. Define Global Requirements
e. Build Guidelines

4. Execute (6004):
a. Coordinate Logistics
b. Mine Data
c. Create Intelligence
d. Collect and Groom Data
e. Organize and Parse Data

5. Assess (6005):
a. Design Reports
b. Calculate Matrix
c. Interpret Results

6. Adjust (6006):
a. Make Recommendations
b. Develop Documentation
c. Train Staff
d. Complete Hand-off

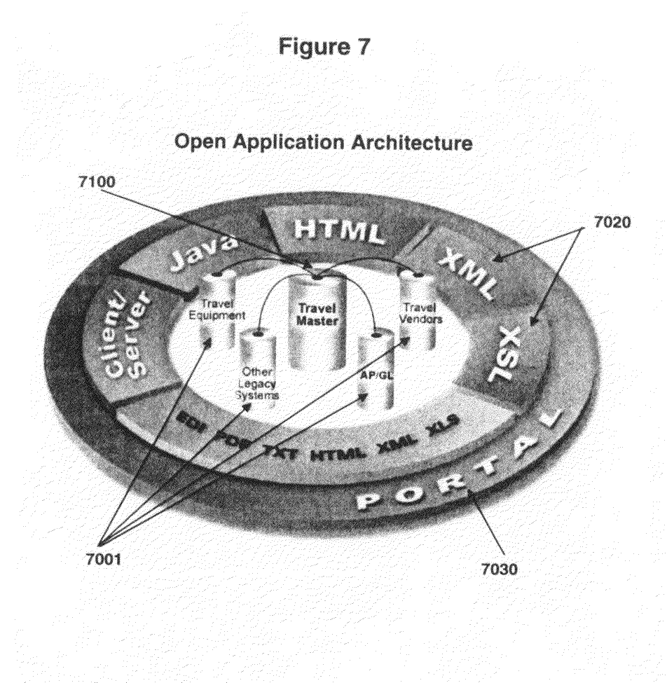

### FIG. 7: Open Application Architecture

This diagram depicts the open architecture in which the invention utilizes—N-Tier and fully scalable—and shows the data coming into the database (7100) from the travel, card and legacy sources (7001) and then being integrated and presented in various formats (7020) and delivered in a portal type layer (7030).

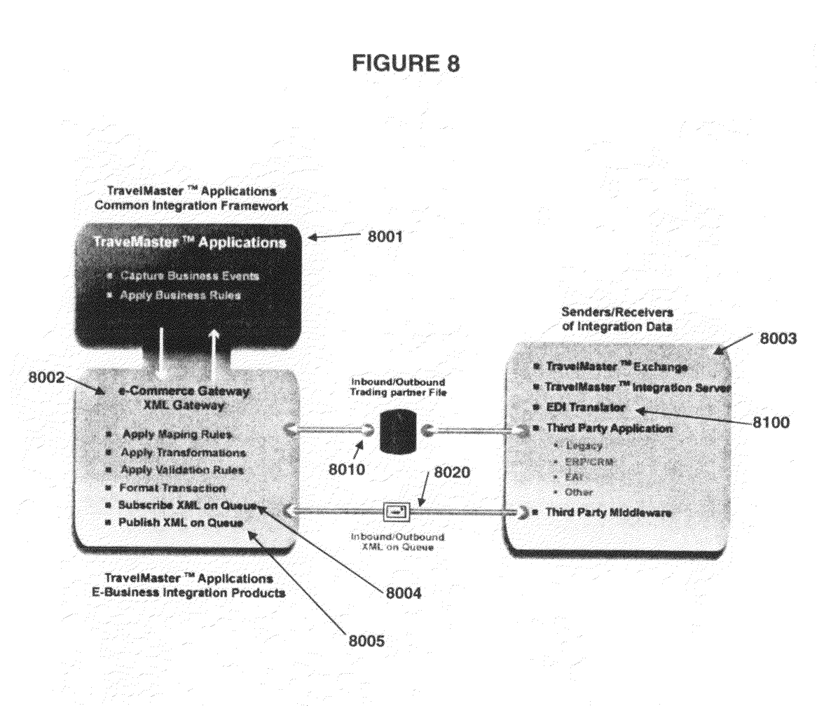

### FIG. 8: Common Integration Framework

This diagram depicts how the common integration framework of the invention allows for both inbound and outbound data communication between the system and other applications. The Steps are:

1. The TravelMaster™ Applications (8001)
a. Capture Business Events
b. Apply Business Rules

2. e-Commerce/XML Gateway (8002)
a. Applies Mapping Rules
b. Applies Data Transformations
c. Applies Validation Rules
d. Formats Transaction
e. Subscribes XML on Queue (8004)
f. Publish XML on Queue (8005)
[symbol] inbound/outbound travel and card trading partner file [symbol] (8010)
[symbol] inbound/outbound XML on Queue [symbol] (8020)

3. Senders/Receiver of Integration Data (8003)
a. TravelMaster Data Exchange
b. TravelMaster Parsing and Integration
c. EDI Translator (8100)
d. Third Party Applications (i.e. Legacy, CRM/ARP, EAI, and other)
e. Third Party Middleware

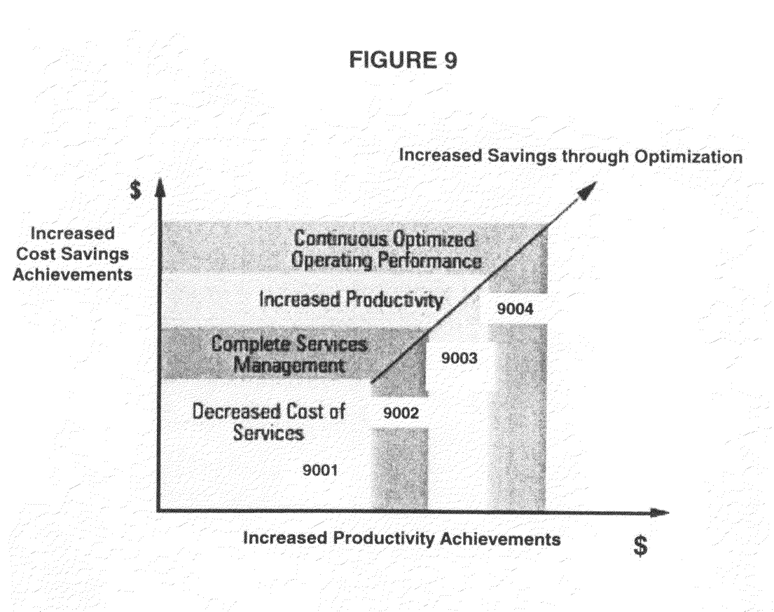

### FIG. 9: Four Levels of Total Travel Cost Management

There are actually four levels to Total Travel Cost Management:
1. The first level of cost management is decreased cost of services (9001), which is where most companies are today in travel cost management. Company has gained a base level of decreased cost of services, picking the lowest hanging fruit through simple negotiations with airlines, rental cars, travel agency, hotels, etc. Company has organized things a little better and set better policies to support those efforts.

But the company can only go so far because it is constrained by the abilities it has from a technology standpoint with what is currently available, especially in a volatile space like travel, where everyone is constantly in motion and the disparate data sources are not integrated and are very difficult to manually integrate in a meaningful way. Today, travel cost management is more reactive than proactive. By the time one area of leakage or additional savings is identified and researched, there is a realization that with industry changes and multiple other areas of travel cost management have been unidentified and have not been dealt with. This becomes a vicious cycle.

2. The second level an enterprise must achieve is complete services management (9002). This level can only be achieved through the utilization of technology, especially in travel cost management, which is extremely detail intensive (e.g., for a medium size travel program there may be as many as 6,000 or more travel itineraries per month, and the travel manager does not receive data until 30 to 45 days later; further, data from various sources is not integrated). While there is some technology in place today that provides some pieces of the puzzle of travel management from a technology prospective, the technology available is separate and non-integrated applications. Many of the available applications are not robust, and although they do arm the company with some information, currently travel cost management still depends largely on manual integration of data from various data sources.

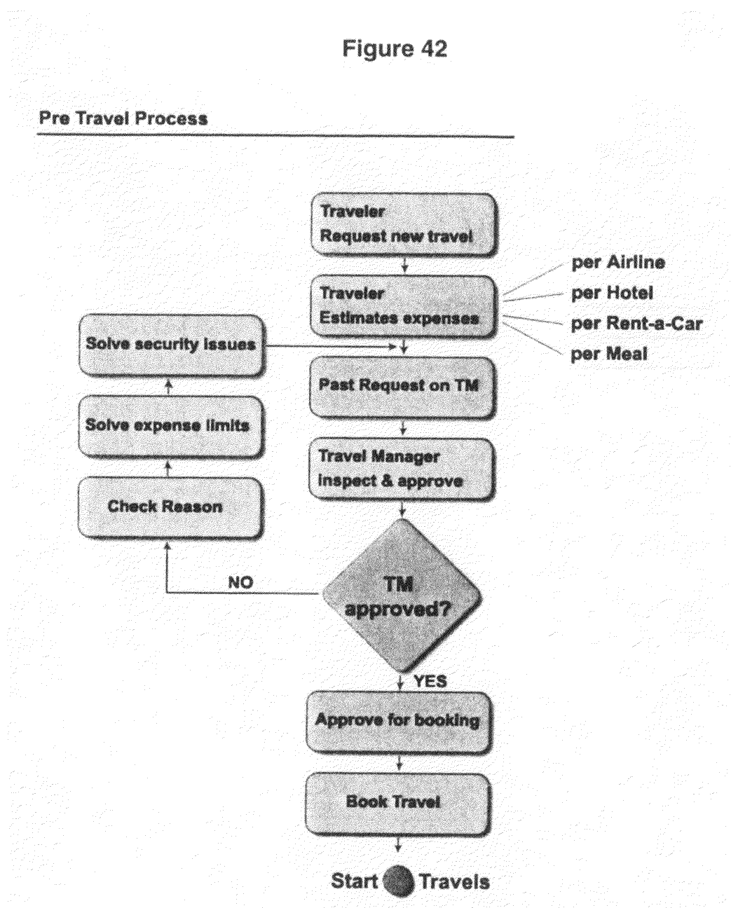

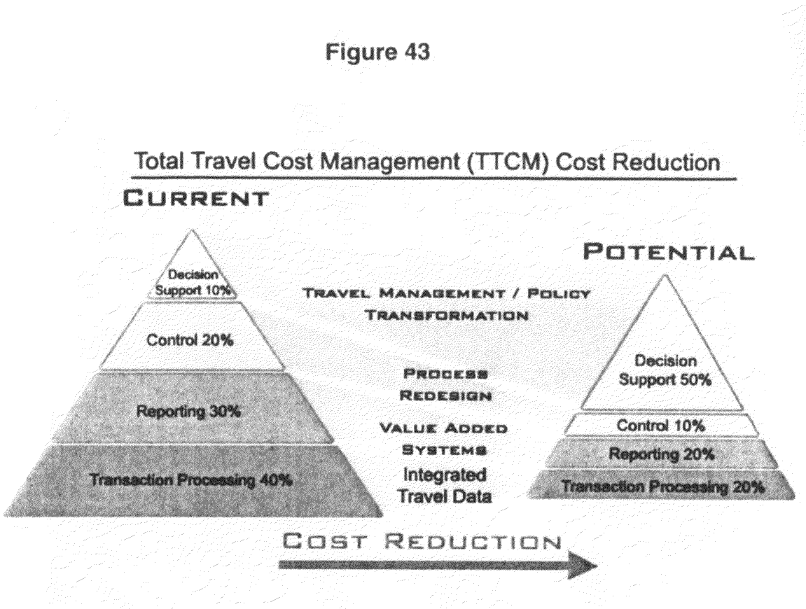

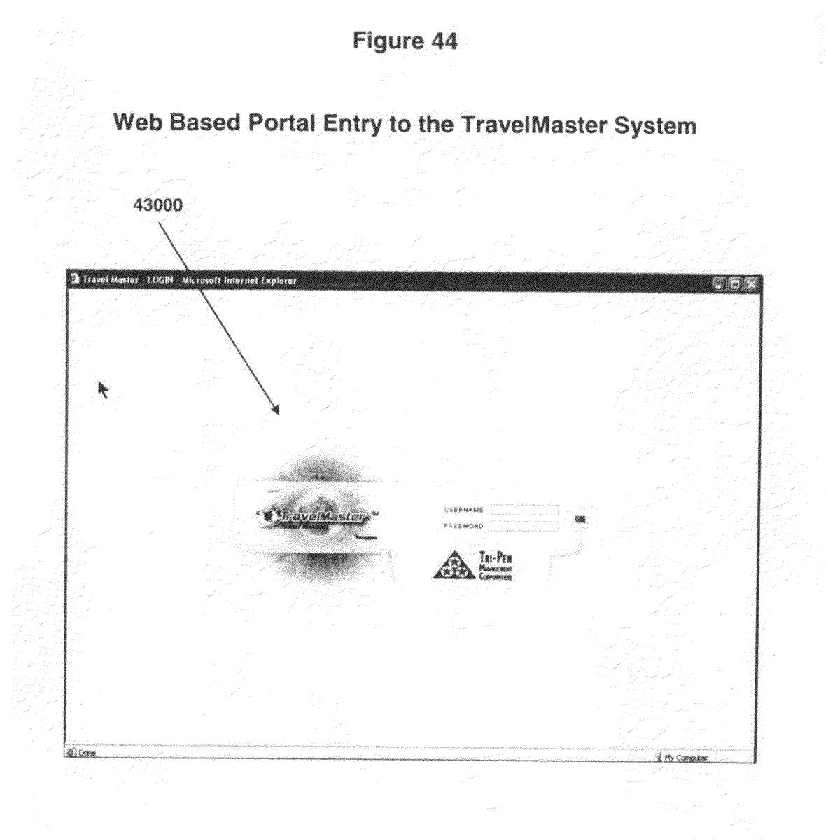

What has never existed previously is the present invention's technology that provides a comprehensive end-to-end solution for total travel cost and service management. The system is designed to facilitate the rapid maturity within an enterprise to achieve complete travel management driving compliance and the real-time complete visibility and control of non-compliance by giving the management team responsible for travel approvals complete detail regarding both travel policy exceptions that happen during the booking process, as well as flagging travel policy exceptions that that occur while travelers are en route all in real time, as bookings and en route travel is taking place. The real time aspect is a critical component of the system, in that it gives the travel management team and all authorizers the ability to see what has been done immediately, and gives the management personnel the ability to question the traveler relative to what they are doing and to approve or deny expenses at the point of booking or at the point that the exception occurs, as depicted in FIGS. 42 and 43.

So, once an organization or an enterprise has achieved total travel cost management, they are enabled to utilize internal resources better and increase the productivity of those resources dramatically.

3. The third level an enterprise must achieve is complete increased productivity (9003). Because of the new technology that the system brings to the process, the company will be empowered to take real control of the total travel environment, thus allowing the enterprise to properly deploy resources to specific tasks, and allowing senior level management such as financial executives, security directors, travel purchasing teams and the like to interact with the technology in such a way that productivity is increased. Therefore, cost management in real-time driven by the system's technology will achieve greater levels of savings, and key individuals within the organization are not wasting time running unnecessary reports, trying to manually analyze data from multiple sources, identifying rate errors and verifying contract compliance.

Increased productivity in and of itself will result in decreased costs due to the ability to go ever deeper in managing the travel and enabling real pro-actively negotiated discounts with travel suppliers such as airlines and hotels.

4. Once an organization has achieved this level of productivity they are able to take a step back and focus on continuous optimization and operating performance (9004) of the entire travel function and travel needs of the organization. The company or enterprise is then able to pro-actively react to the changing needs of the enterprise on a continuous basis. This will allow them to optimize their own time to market the enterprise's competitive advantage by insuring that the right services are implemented at the right time with the right suppliers at the right price, as further depicted in FIG. 43.

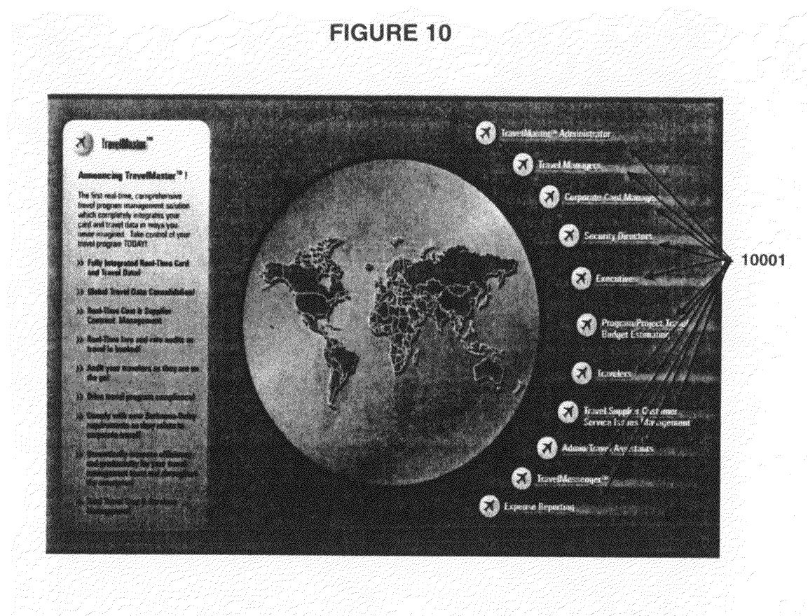

### FIG. 10: Invention Typical User Types/Roles

This diagram represents the typical types/roles of users (10001) that will use the invention. Users, roles and types (10001) are 100% customizable by the client.

Todays corporate travel management programs are very diverse in size and organizational structure. Due to the need for organizations to be flexible and to manage their travel related data and programs in a way that meets the needs of the organization, the system provides the ability to define types, roles and users (10001) dynamically as needed.

### FIG. 11: Representation of a Typical Travel Manager Screen

This figure is a representation of a typical screen of the present invention showing features and functionality that a Travel Manager would use.

For the typical Travel Manager user, the most important feature is screen area (11001), which shows travel bookings data (taken from the travel agency feed) and what is happening as the travelers are on the road en route. Integrated corporate card and travel data has never been presented to the travel manager in real time, thus the system lends an unprecedented level of transparency through actions such as capturing travel policy exceptions which occur en route as they actually happen, real-time audit of airfares being sold to corporate travelers as the reservations are being processed, real time audit of negotiated rates as travel is taking place, and other such actions that have never previously been possible in the travel management process. Throughout the system's application, this integrated corporate card and travel data has been standardized and presented to the user in a format (FIGS. 11 through 27) that allows complete transparency of what is occurring in the travel program and empowers the user to be able to make decisions and take charge of the corporation's travel in significant, meaningful and efficient ways never before possible.

Other features and functionality on this page include screen area (11002), summary data regarding the travel program which gives the travel manager an overview of the integrated card and travel data.

This area of the screen (11003) allows the Travel Manager to view and act for all pending items which require approval.

Screen area 4—(11004) is an area for meetings and action items and an in-box area for incoming items from travelers and other team members.

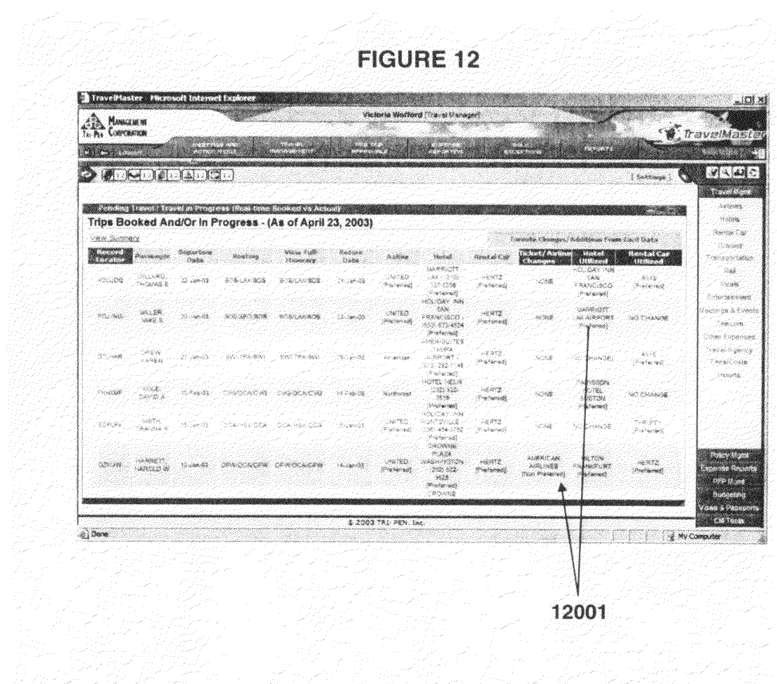

### FIG. 12: Representation of a Typical Travel and Card Data Integration Screen

FIG. 12 is a representation of a typical screen of the present invention showing integrated travel and corporate card data and how this integrated data can be used to identify changes travelers make while en route.

This is a different screen view which solely presents to the travel manager, in a dynamically integrated fashion, integrated travel and corporate card data in real time—as travel is occurring on the road and changes are being made en route by the travelers. The program automatically flags changes (12001) that result in additional costs, as those changes may prevent the corporation from meeting their goals with preferred vendors, which have extended negotiated rates to the corporation.

This level of detailed reporting in real time enables the travel management team to contact the traveler on the road in real time to request justification either via voice or via e-mail enabled handheld devices. It is anticipated that the simple knowledge of this level of visibility on the part of the travelers will drive travel policy compliance. No travel management department has ever before had the transparency and visibility into the process of the actually dynamically happening travel previously. This functionality allows the travel management team a level of control over the process that has never previously existed. Previously, a travel management team would have to manually integrate data from different sources, working with data, which was 30 days or more old. In even a medium size travel program with 3,000 trips or more each month, the task of integrating the detail for each traveler would have been a monumental task that would have been extremely difficult or impossible to accomplish.

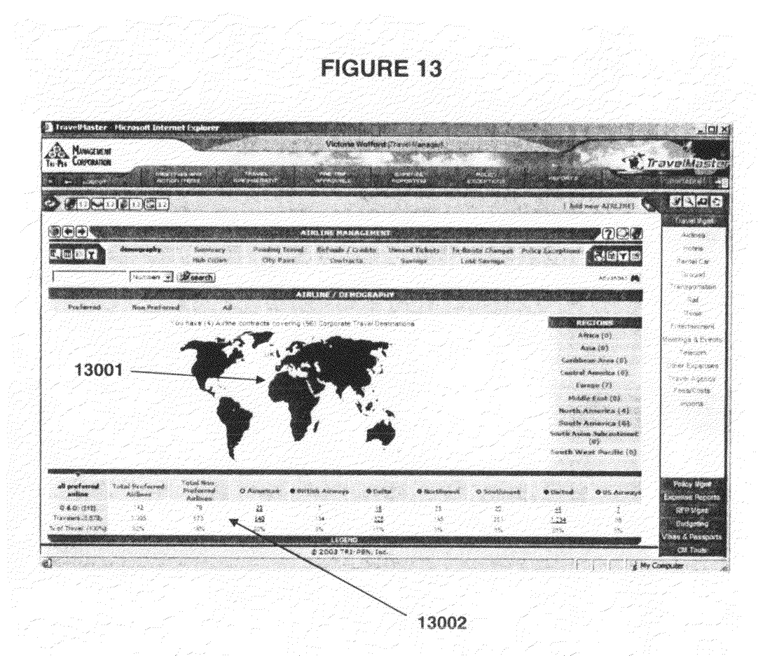

### FIG. 13: Representation of a Typical Airline Management Screen

FIG. 13 is a representation of a typical screen of the present invention showing Airline Management interface with accumulated booking, travel and card data. This screen shows the travel management team a demographic representation (13001), as well as statistical data (13002) regarding the coverage represented by their current airline discount contracts in place with the corporation's preferred vendors. The screen is designed to highlight whether or not the travel management team has made good choices in terms of the preferred airlines that have been accepted into the program. Further, the screen will highlight whether those choices continue to be good choices for the corporation's travel.

A corporate travel program is extremely dynamic and individual from one corporation to the next. Travel patterns of the corporate travelers may change from month to month or even week to week based on current clients, current programs changing, new clients, new programs and new product lines which require travel to new and previously unvisited destinations. Consequently, it is very important for the travel management team to be able to establish in real time how well their current airline contracts meet the needs of the business travel requirements of the corporation.

Previously, most travel teams did an analysis once or twice a year relative to the coverage they gained from current airline contracts and relationships. Consequently, the “leakage” (travel which might take place without any negotiated discount being in place, which increases the cost to the corporation for that travel) has in the past been quite high in many travel programs. The present system solves this problem by automating the travel management team's ability to see at a glance what kind of coverage their airline contracts/relationships are providing to their travelers on a daily basis.

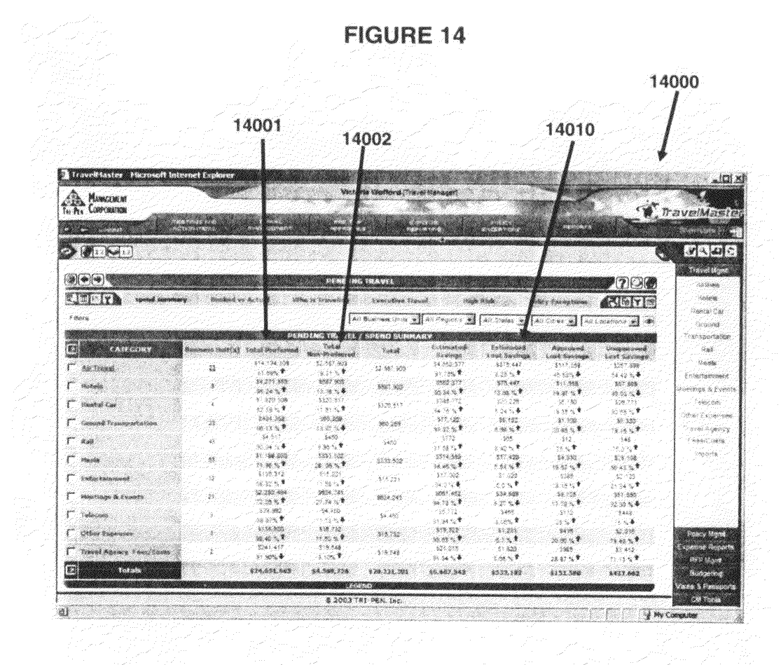

### FIG. 14: Representation of a Typical Summary of Total Travel Spending Screen

FIG. 14 is a representation of a typical screen of the present invention showing a summary of all pending or approved travel related spending for both travel and corporate cards in a single interface. This screen (14000) gives the travel management team immediate insight into bookings at all preferred vendors (14001), versus bookings of non-preferred vendors (14002)—as well as the cost savings/lost (14010) associated with these bookings.

Further, drilling down from this screen to the detail which comprises this summary allows the travel management team to identify the individuals who have booked non-preferred vendors or have otherwise booked travel which is a violation of company policy and allows the travel management team the ability to contact these travelers in real-time and potentially shift volume back to preferred vendors in some situations (especially situations where travelers have chosen specific vendors for their own reasons, such as frequent flyer mileage considerations in lieu of choosing the most economical mode of travel as per the company travel policy).

Since travel management teams have previously been working with data that is past-date travel that has already taken place, they have never before been empowered to make changes to the travel of their personnel which creates cost efficiencies on the spot as the system does.

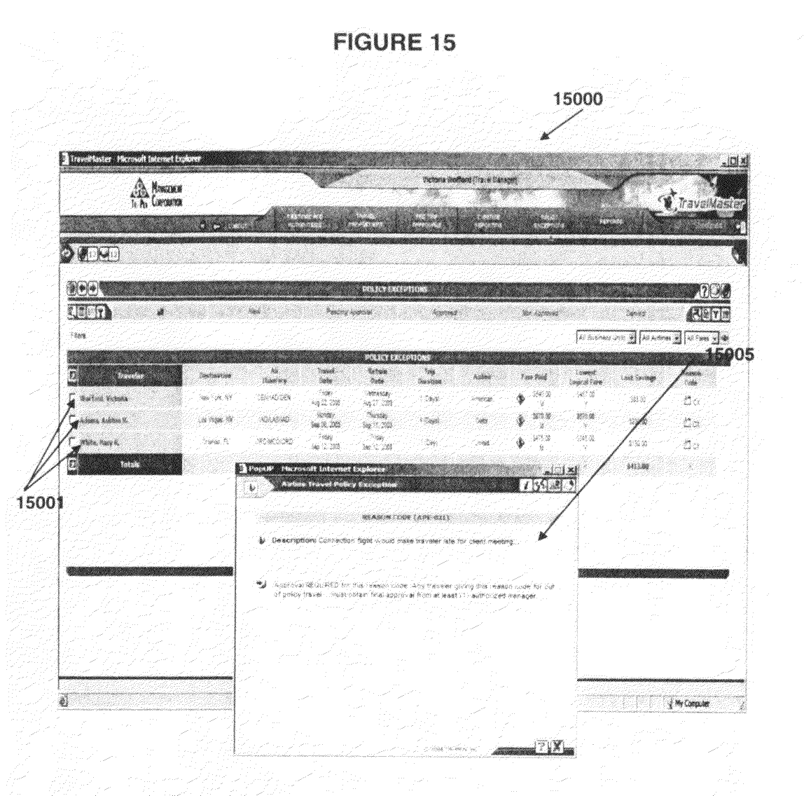

### FIG. 15: Representation of a Typical Policy Exception Screen

FIG. 15 is a representation of a typical screen of the present invention showing how companies using the integrated data can identify policy exceptions before they happen and facilitate the approval process. This image (15000) follows FIG. 14, above, and highlights how the travel management team immediately identifies individuals (15001) who have booked travel components which are exceptions to the corporation's travel policy, allowing the travel management team to action such components directly with the individual traveler, or at least to ensure that the traveler is contacted regarding the non-compliance issues in such a way that the traveler is aware that their non-compliance is highly visible and is being noted.

Further, non-compliance is flagged within the system, and authorization at higher levels is required relative to compliance issues (15005). This is especially critical in the expense reporting process, where today many non-compliance issues are glossed over because the traveler committed the breach of policy weeks previously. Many companies today have only cursory audits of expense reports, and even non-compliant expenses are paid by many companies due to the lapse of time and the lack of visibility into what was available to the traveler at the time the traveler was on the road.

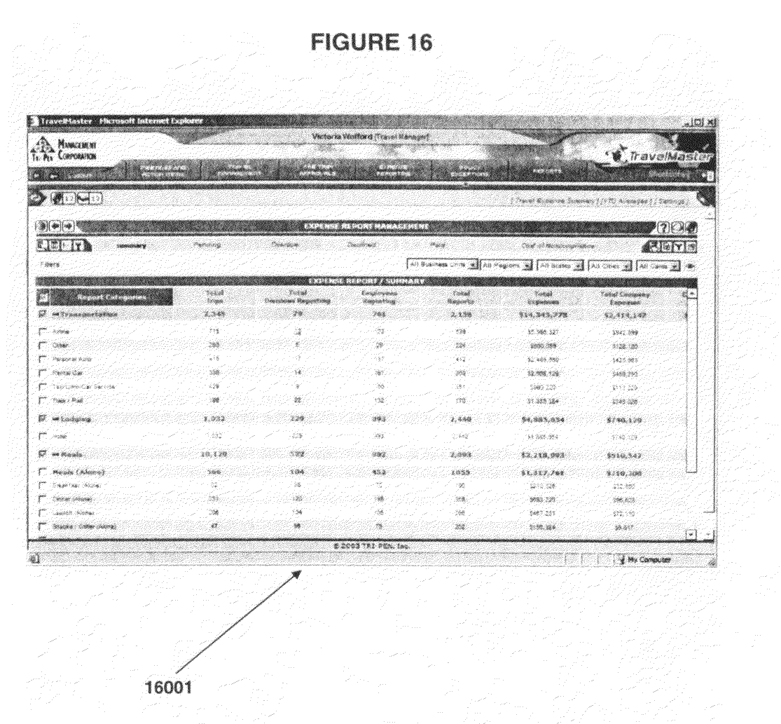

FIG. 16: Representation of a Typical Expense Reporting Summary Screen

This figure is a representation of a typical screen of the present invention showing the expense reporting module (16001), displaying integrated data from all travel and card sources at a summary level. This particular summary data is especially important due to the fact that in virtually 100% of all corporate travel programs, the travel management team has very little transparency into the total expenses incurred on the road, especially expenses that may have been paid with cash, or may have been paid utilizing a personal credit card.

The system takes into account how valuable insight into the actual expense reporting data is to the travel management team and summarizes this data for them from the expense reporting module in order to allow the travel management team to leverage their negotiations with travel suppliers based on the total correct travel volume of the company (as opposed to negotiating based solely on bookings data which is subject to change or cancellation at any time).

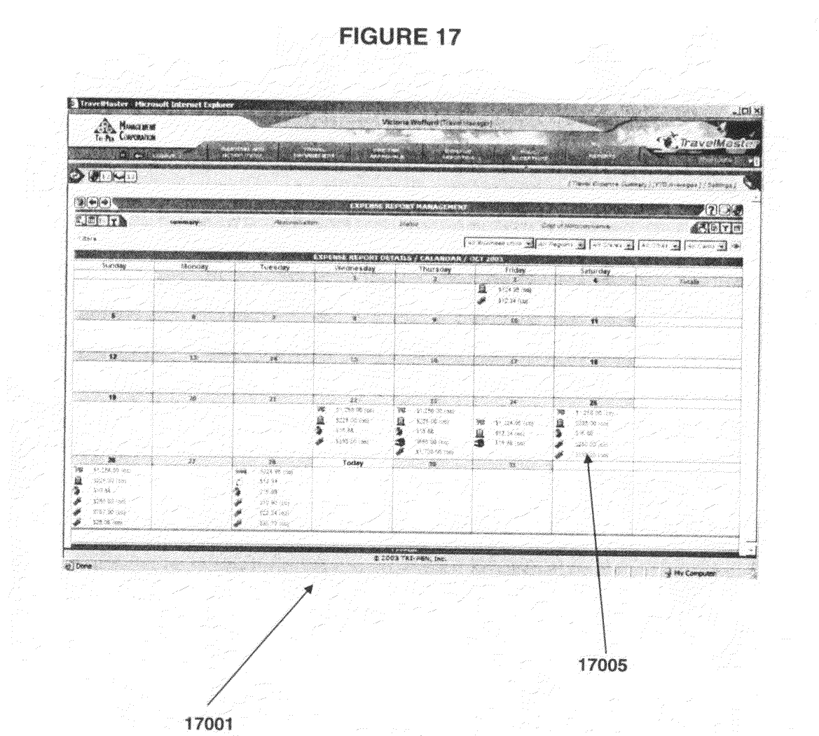

### FIG. 17: Representation of a Typical Traveler's Expense Report Details Screen

This figure is a representation of a typical screen of the present invention showing the interfaces within the expense reporting module which will be utilized by individual travelers and their assistants. This particular image shows a calendar view of the traveler's past and future trips displaying integrated data from all travel and card sources at a detailed level by month (17001). The system has the ability to differentiate between and highlight for the traveler which data being viewed comes from the travel agency bookings data and which data comes from the corporate card data (17005). Further, since the data displayed to the traveler is archived and available to the traveler at all times, the traveler has the ability to reference the data at any time they wish to repeat a trip or utilize the same supplier again. Having this data available to the traveler will increase their productivity and efficiency in the travel planning process.

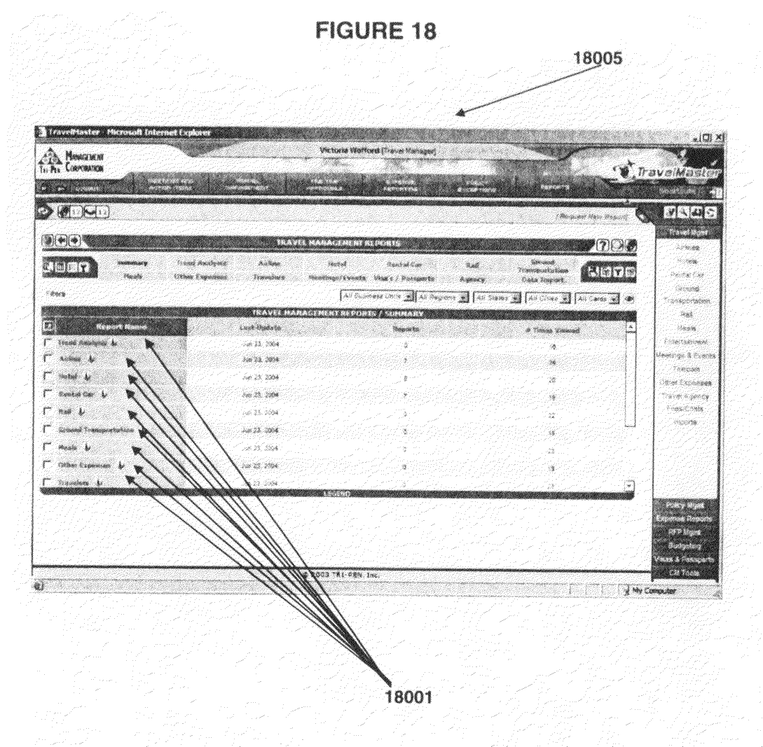

### FIG. 18: Representation of a Typical Report Access Screen

This figure is a representation of a typical screen of the present invention showing the main reports screen (18005), allowing a user to choose and create reports (18001) for integrated and separate data analysis. This module of the invention is particularly powerful for the end user, as it allows them to choose from standard reports (18001) which are pre-built in the system and then populate the data for any time-frame they desire at the touch of a button.

Further, this module allows travel management teams to build customized reports (18001) based on either corporate card data, travel data or integrated data from both sources, and thus compare and analyze the behavior of their travelers on the road and determine needed changes to the travel program in order to best support their travelers.

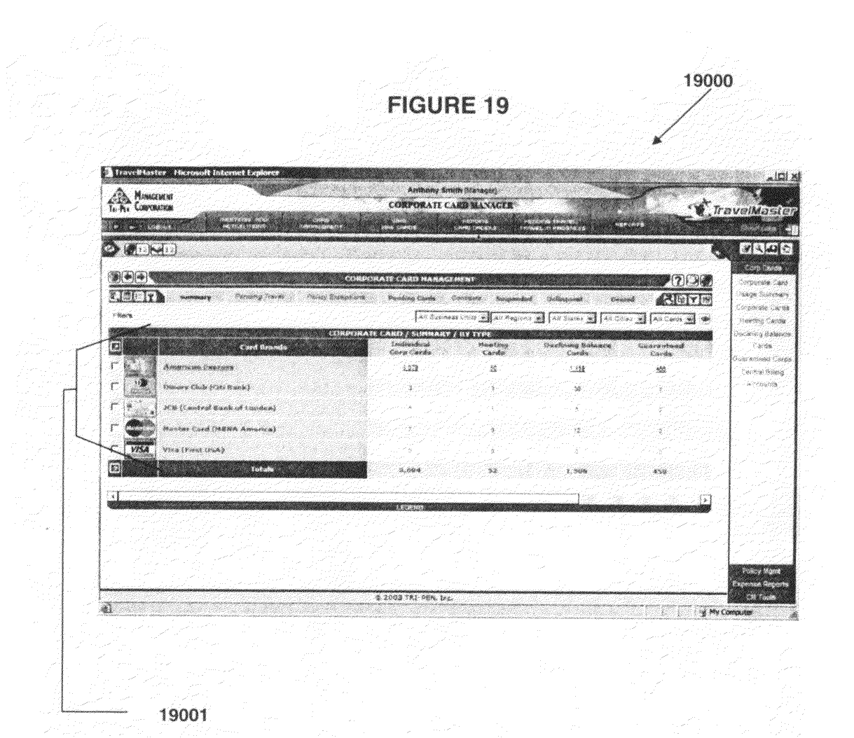

### FIG. 19: Representation of a Typical Airline Management Screen

This figure is a representation of a typical screen of the present invention showing a typical corporate card management interface (19000), displaying all cards and card types (19001) utilized. This module of the invention allows the travel management team more control over the corporate card program, down to the individual card holder level, than has never been available previously on a real-time basis.

The user can at a glance see what cards they have outstanding worldwide, or in a single business unit. Utilizing the areas of this module that present individual cardholders who are delinquent or suspended allows the travel management team to action these issues in real-time with the traveler, thus preventing any loss of money to the corporation in a pro-active scenario.

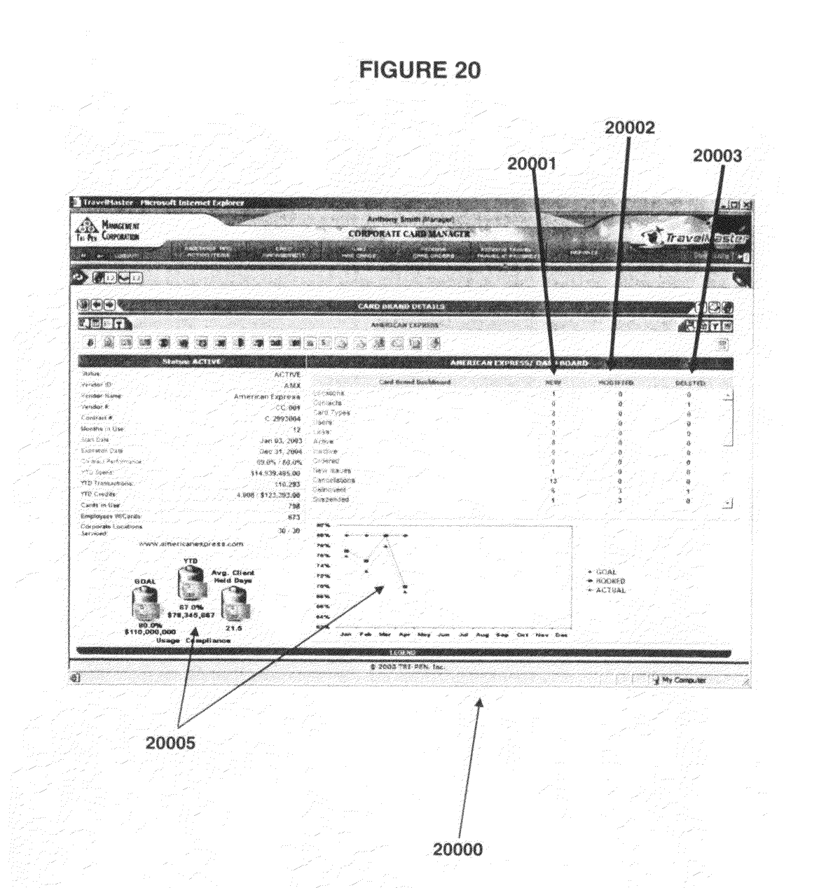

### FIG. 20: Representation of a Typical Corporate Card Performance Overview

This figure shows how a corporate card manager or other related personnel would access detailed information in regard to the Credit Card Company's products and services the company uses within the organization. This screen (20000) summarizes the status and other key attributes of the Credit Card Company and gives compliance and performance measurements (20005) that are compared against contract and actual T&E reporting. The trend analysis (20005) shows a typical example of how the “Integrated Card and Travel” data can be viewed and displayed to a user, giving them the transparency needed to empower them to make the right decisions for the travel program. This screen in the current invention also provides a dashboard for reviewing “NEW” (20001), “MODIFED” (20002), or “DELETED” (20003) items.

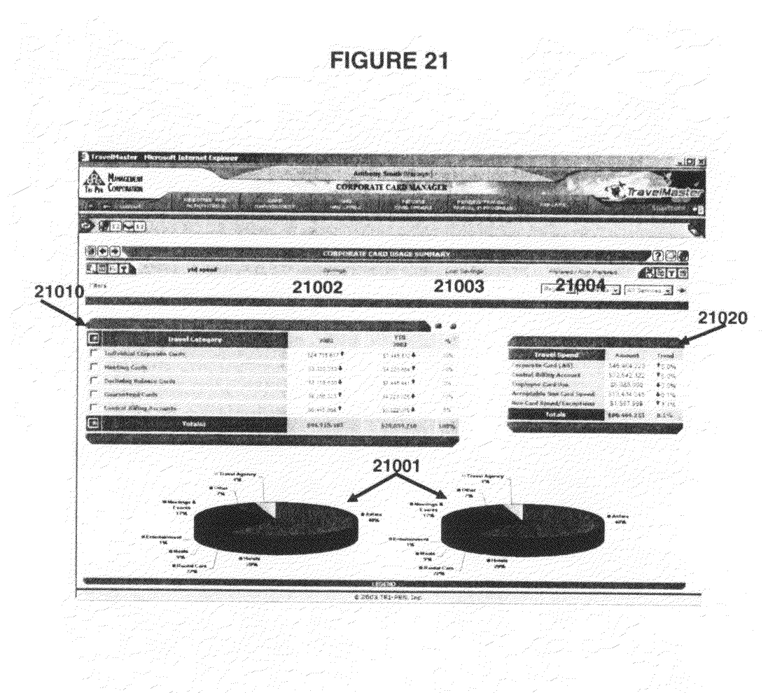

FIG. 21: Representation of a Typical Total Card Report vs. Travel Spending Screen

This figure shows another prime example of how the current invention utilizes the newly combined card and travel data format to display a summary of spending for the card product utilized (21010) and an immediate comparison to the actual travel spending within the organization (21020). There is no longer a need for separate reporting, interfaces or diagrams. The system integrates the data and allows the user to view this in a standard format that every organization can understand, utilize as needed and take action on. Graphical representations (21001) of the data are also displayed and easily accessible to the end user.

This screen also provides access to savings (21002), lost savings (21003), and comparative analysis against preferred and non-preferred card suppliers (21004).

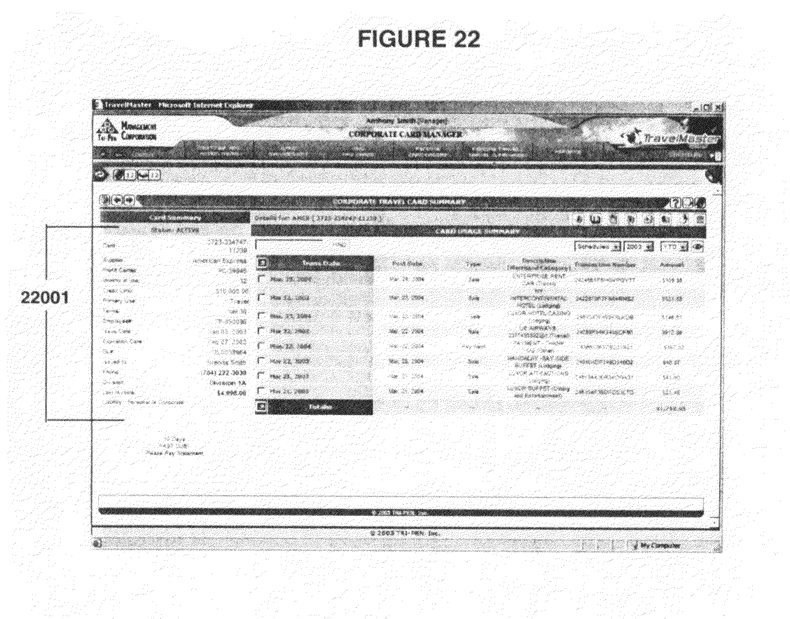

### FIG. 22: Representation of a Typical Corporate Card Holder's Screen

A screen representing how a traveler, Card Manager, Travel Manager or other authorized personnel can access and review in “real-time” the charges that a traveler incurs while traveling is shown. The data is taken from the actual booking and PNR information provided by the GDS, Travel Agency, or ATDS and matches it with the actual card usage data coming from the Corporate Card supplier. The integrated data is displayed to the end user as the charges occur throughout the lifecycle of the trip.

The interface also provides for summary of payment, expiration, usage, credit limits and other pertinent data (22001). The traveler may also see data relative to card payments they have made, disputed items, and credits they have requested.

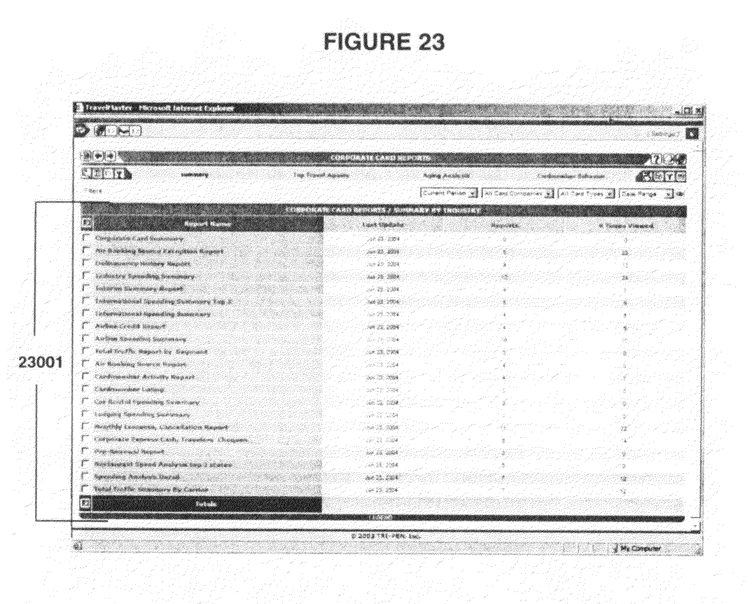

### FIG. 23: Representation of a Typical Card Management Reports Screen

Reporting is a key component in the invention because reporting allows a user to quickly access default and pre-defined reports (23001) that seamlessly integrates the data from both card and travel sources. This data is then displayed to the user in a variety of formats including, but not limited to, HTML, PDF, TXT, XLS and other commonly utilized data and reporting formats.

Users may also create custom reports as needed because the invention gives the user the ability to select data elements from any interface screen and quickly combine them for “on demand” reporting for card and travel data.

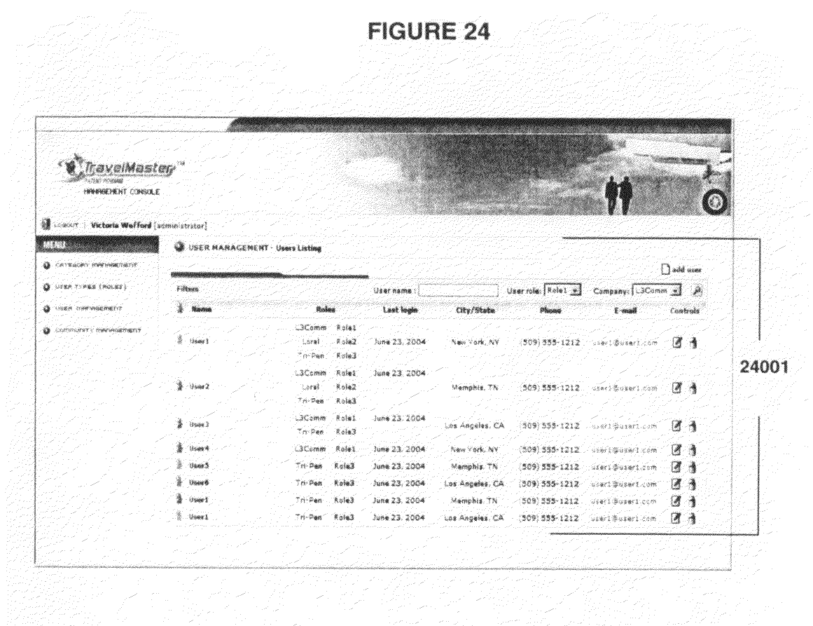

### FIG. 24: Representation of a Typical TravelMaster Administrator Screen

This figure is a representation of a screen displaying the management console. The screen represents the current invention's ability to manage the user types and the interactions that those users will have with the system (24001). Administrators can control import/export and other parameters related to data integration and workflow that drives the system to meet the needs of the organization.

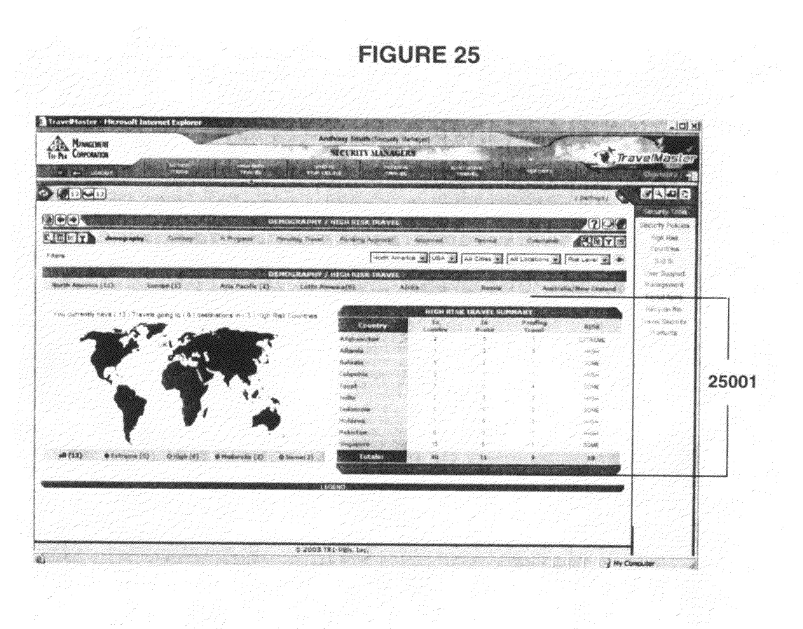

FIG. 25: Representation of a Typical Security Director's Screen

Another unique and highly valuable use for integrated card and travel data is for the security directors and managers within an organization. This screen (25001) represents a typical interface that a Security Director may utilize in the current invention for tracking high-risk travel and related policies.

The integrated card and travel data proves very useful for security with the organization. As the interface (25001) shows, it allows the manager to track who is traveling (25010), high-risk travel that is booked (25020) or pending (25030), executive travel (25040) that may be to high risk or potentially dangerous countries and more. Obtaining actual booking data immediately provides for quick and decisive action in regards to high-risk travel and the policies the govern it.

With the integration of the card data, managers are able to track travelers to ensure they are staying in approved secure hotels and other facilities. The integrated data also ensures compliance on multiple levels and helps to ensure travelers do not deviate from the plan.

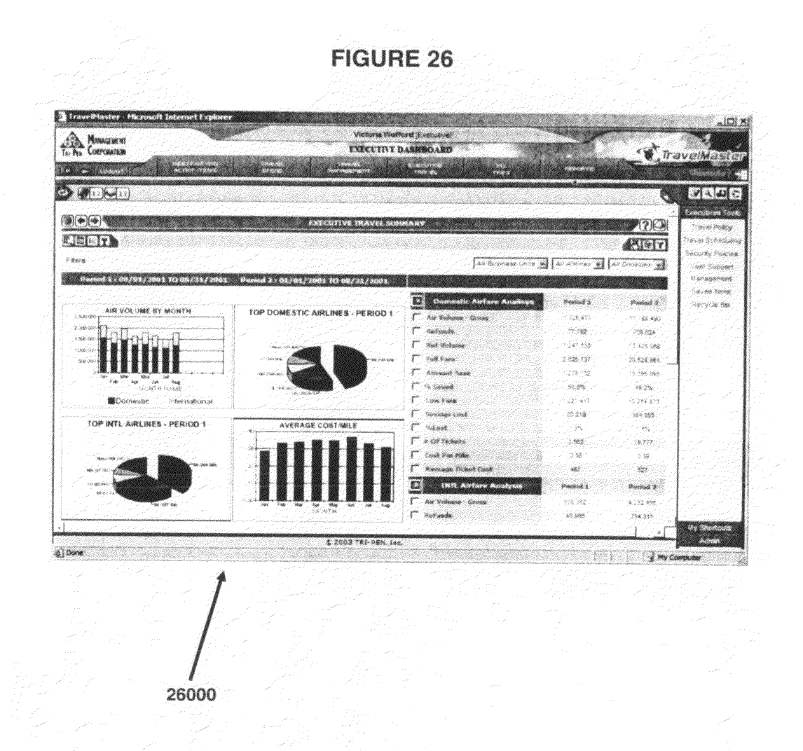

### FIG. 26: Representation of a Typical Executive Management Screen

Executive decision-making plays a key role in the success of any company. Integrated, accurate and real-time data is critical for today's global economy. This screen (26000) represents how the current invention provides a command and control center for company executives, allowing them to view travel and card data both real time and integrated, neither of which was ever previously possible. The invention thus empowers executives and decision makers with a proactive approach to managing travel, policies and related expenses. This new data format changes the way organizations can react, providing key insight into card and travel data and transporting them from having to react when it is to late to proactively making decisions that positively impact the bottom line.

This type of seamless travel and card data integration into a common understandable and presentable format is the essence of the invention, and will change the face of travel management.

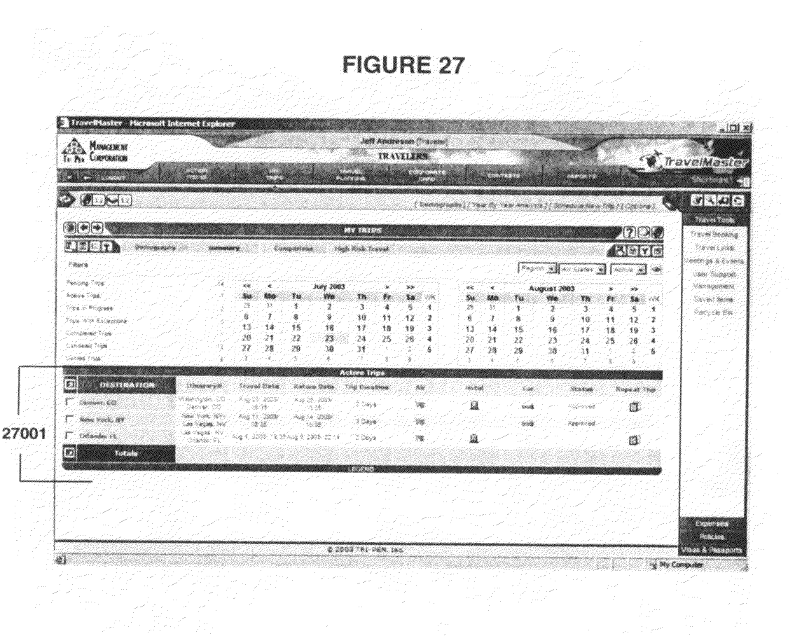

FIG. 27: Representation of a Typical Traveler Screen

This screen in the present invention represents how a traveler may interact with the system, which allows access to current, completed and future travel plans. Travelers also have access to corporate card data and usage compared with T&E. The invention tracks booking information (travel data) and dynamically compares it with the actual information (card data) as the trip progresses (e.g., as the traveler is booking and completing travel and using the corporate card to pay for travel expenses) (27001). This information is gathered in real-time and integrated by the present invention and then presented to the end user.

Travelers also have access to other management and travel related tools and features such as:

1. profile and travel preferences;

2. cards on file;

3. frequent guest and award programs;

4. visa & passport;

5. policies;

6. online booking engine;

7. reporting;

8. data comparison;

9. instant communication;

and much more.

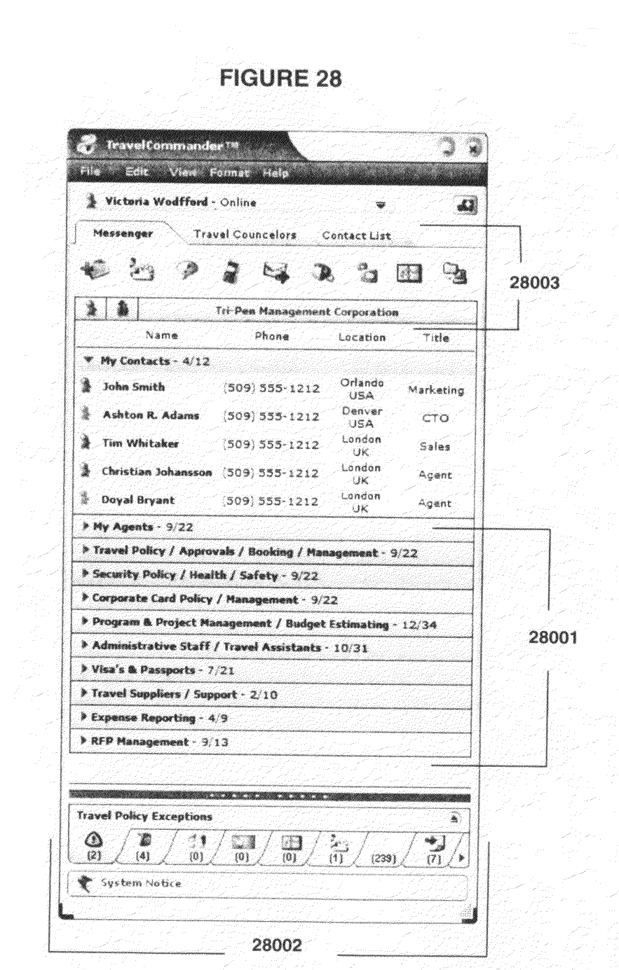

### FIG. 28: Representation of a Typical TravelCommander™ Module Screen

TravelCommander™ is a feature within the current invention. This screen shows how the integrated data 28001 and 28002 can be quickly accessed by users of the system in an instant messaging and collaborative interface. As travel is booked, policy exceptions take place, cards are used, approvals are needed, meetings are planned, information is needed and requests are made. This integrated travel and card data is quickly made accessible to the end users in real-time. Users are able to interact in ways they have never dreamed of, facilitating communication, negotiation and collaboration between every party involved throughout the travel and management lifecycle.

This screen is packed with features (2801, 2802 and 2803) such as:

1. file sharing;

2. instant communication with a Travel Counselor;

3. web sharing;

4. application sharing;

5. SMS communication;

6. VoIP;

7. E-mail;

8. chat/instant messaging; and

9. Web conferencing.

This tool shows in detail how the current invention can present the integrated travel and card data in vastly different ways.

Because many varying and different embodiments may be made within the scope of the invention concept taught herein which may involve many modifications in the embodiments herein detailed in accordance with the descriptive requirements of the law, it is to be understood that the details herein are to be interpreted as illustrative and not in a limiting sense.

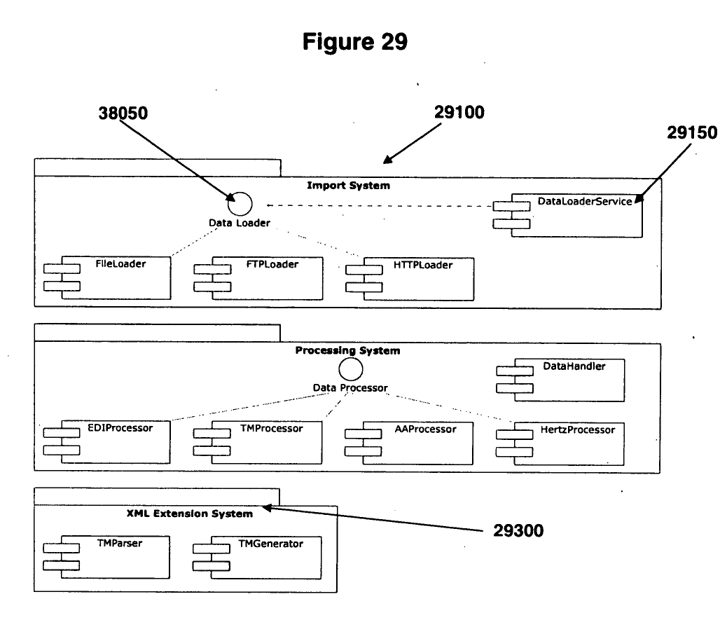

### FIG. 29: Diagrammatic Representation of the Import System, Processing System and XML Extension System

This figure shows from a workflow perspective how the data import system (29100) interacts with the data loader services system (29150) to load the data into the appropriate part of the database structure (38050) and further processing of the data which can then be generated into the XML Extension System (29300) and parsed for proper display in the various system interfaces.

FIG. 30: Diagrammatic Representation of the TravelMaster Manager System

This figure shows how the permissions manager (30001) interacts with the User Manager (30003), and the Role and Group Managers (30005) in order to ensure that when an individual is authenticated by the system (30010), the correct sets of data are displayed for the specific user based on the rights and permissions for the role played by the specific individual in the travel management process based on what is desired by the company.

### FIG. 31: Diagrammatic Representation of the Writer System

This figure shows how the various writer systems (31105, 31110, 31115) within the system interact to ensure that the proper data is displayed in the interface screens. It supplies the basic target implementations such as Plaintext and HTML. Database Writer (31115) provides the accessibility to a relational database storage support. In this manner it provides the reporting system with information for dynamic reports and analysis.

### FIG. 32: Diagrammatic Representation of the Message Delivery and Message Transport Systems

Message Delivery System

The message delivery system component (32020) provides the notification mechanisms in two ways, synchronous (32005) and asynchronous (32010).

Message Transport System

The message transportation system component (32050) provides the transport mechanisms for various types of destinations. It can notify the system with messages usually used to be displayed as banners or general interest information. It provides implementation for e-mail SMS notifications and integrates with most used messengers such as ICQ, AOL, MSN Messenger, Netscape, Yahoo and others.

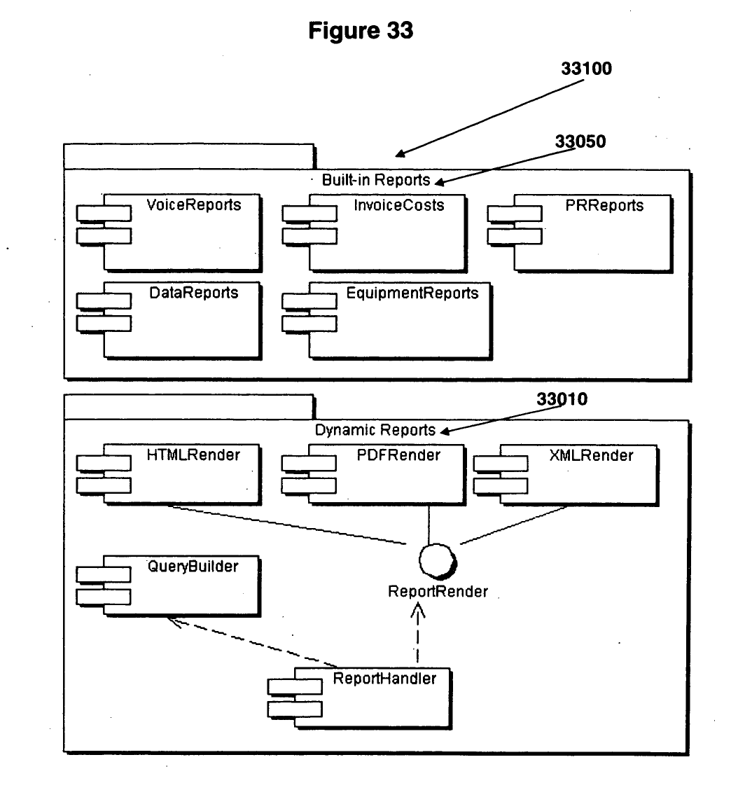

### FIG. 33: Diagrammatic Representation of the Reports System

The system flags areas of action that will either improve service quality or lower the overall cost basis of the travel budget. The most effective reporting tools among the system's solutions are those that present a clear analysis that enables an actionable event. The system is flexible to permit this. Critical to that process is the prioritization of required actions. Reports that show estimated dollar impact make planning and sourcing decisions that much easier.

No other solution available to companies today provides a reporting mechanism for enterprises to visualize and analyzes the complete aggregate travel spending and integrated corporate card data—across all services, vendors and business units—to allow simplified decision-making processes (36010). Whether the enterprise or the vendor hosts the system's solution, a web-based portal (43000) is utilized to access this data, making this invention highly flexible and presents the data in ways never before possible due to the fact that until the existence of the system it was not possible to integrate corporate card and travel data on both the micro and the macro levels simultaneously in real-time and display that data to a user along with complete simultaneous analysis. Examples of these types of interactions and analysis presented to the user along with the integrated data are depicted in FIGS. 11 through 27.

FIG. 34: Representation of the Dynamic Sourcing Module within TravelMaster

As most travel services are billed on a recurring basis, original contract and supplier decisions hold true over time, but new services and travel requests continually cycle through a dynamic demand process. The present invention allows the travel management team to immediately initiate new requests for negotiated pricing to travel suppliers through the invention's automated system and conduct complete negotiations 34100 with said suppliers online, as depicted in FIG. 34.

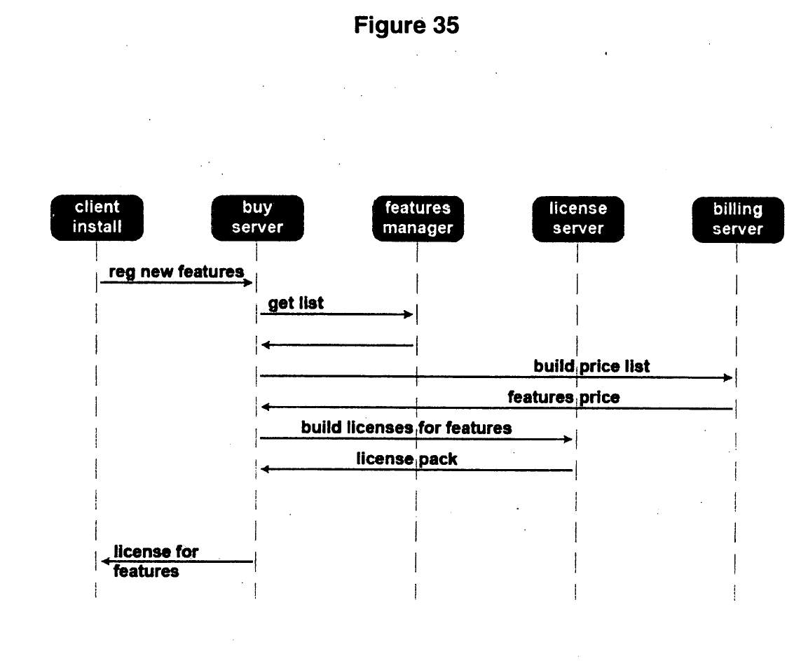

### FIG. 35: Representation of Client Authorization Features

This is a representation of the billing and authorization process for clients using the system, which is a feature of the roles and permissions functionality of the system.

### FIG. 36: Diagrammatic Representation of the TravelMaster Database

The system's database structure and the way in which data is both stored and accessed by the system is one of the keys that enables the system to build requested information in seconds, no matter how large the database of information stored. Where other applications might take hours or days to build a requested report, the system builds and displays the information requested at each screen in seconds.

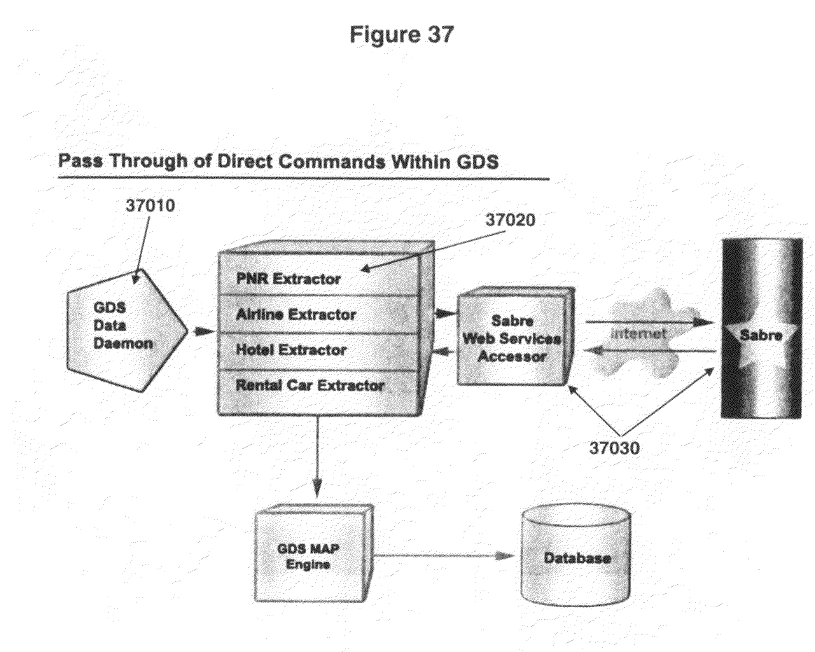

FIG. 37: Diagrammatic Representation of the Pass Through of Direct Commands within a GDS (such as Sabre, Apollo, Worldspan, etc.)

The data from the individual itineraries being booked comes into the system via a secure connection between the system and the GDSs being utilized by the company's travel offices (37010). The system's parser (4001) extracts the data from the PNR (37020). The system then runs commands in the open GDS system (37030) to verify and validate work done by the travel agency during the booking process and audits whether the itinerary as booked by the agency actually complies with the parameters and policies specified by the corporation. Additionally, the system runs commands which bring additional data into the system and displays this data in dynamic reports which allow the corporation to calculate real-time metrics and determine the occurrence of certain types of travel and card related events.

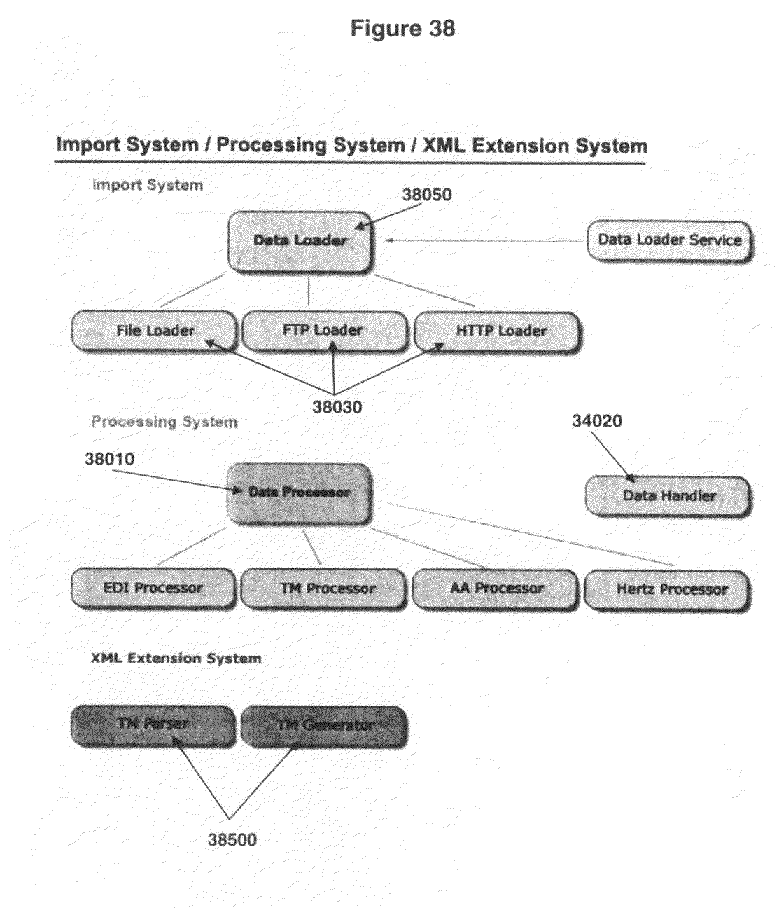

### FIG. 38: Diagrammatic Representation of the Import System/Processing System/XML Extension System

The processing system component (38010) processes data for the system, and the information will be refined. Further, the processing system component is EDI compliant and XML 1 (SIMS format) compliant (1004, 1005). In addition, the component provides vendor-dependent implementations. All storage operations are intermediated by the Data Handler (4020) component as the only database access point. The use of a single database access point makes the module easily traceable and allows the administrator to create system run reports (1002).

### Import System

The import system component (38050) handles the input sources for invoices or other system required information and manages the data load process by taking advantages of processing system capabilities. It has multiple data sources (FILE, FTP, HTTP locations) (38030) and is easily extendable for another data source such as EMAIL, dependent upon customer needs.

### XML Extension System

This XML Extension System component (38500) serves as double-way access point by allowing the export of the information in XML format or the import of the information from a standard XML format. It provides the system with an XML interface, makes the system powerful by using standards, and creates the capability of interoperability with legacy or third party systems.

FIG. 39: Layout Manager

The entire interface of the application is based on skins. FIG. 39 depicts the layout manager. The layout manager takes advantages of Velocity scripting language (39001) to bring the data into the interface (39010 and 39020) to implement that. This permits easy customization of the interface and GUI personalization (39020). The system is easily extensible, just by rewriting the interface generator templates (39005) as a replacement for the entire application or just for a part of it. What creates advantages for an application structured that way is the speed of the interface generation process and the availability to generate the same content (39025) even if the application server that hosts the component is not running. That means the application can easily render the same content without using JSPs or other technologies that depend on the running status of the server.

FIG. 40: License Manager

Every customer support department treats the clients on a license code basis. Treating the customers by their license number improves the business by speeding up the communication and identification process. Also the license management system (40000) as depicted in FIG. 40 encapsulates the identification functionality (40005) and opens or restricts some key system features (40010).

### FIG. 41: Plug In Manager

Some components of the distributed application can work alone, and others request the presence of some implemented modules. A customized module, a new feature module, represents these kind of components that have to be manipulated by a manager as depicted in FIG. 41, and all these components (41010) are named “plug-ins” because they support a well defined connectivity interface and permit runtime activation and passivity or even uninstall.

### FIG. 42: Pre-Travel Process for Approvals

This dynamic diagrammatic representation shows the general workflow and process by which the system automates identification of travel itineraries which require approvals, whether those approvals have to do with cost, policy exceptions, security issues or other issues which may require approval prior to travel taking place.

### FIG. 43: Total Travel Cost Management (TTCM) Cost Reduction

This figure illustrates the change management, decision support and control which supports the cost reductions that take place when a company utilizes the system.

What is claimed in this invention is:

1. A travel and credit card data management method for use with real time corporate travel and credit card data sources involving multiple business units and multiple travelers, for use with travelers, management, and suppliers of particular business units, comprising:
consolidating the data from the sources; and
supplying consolidated data relevant to at least some of the travelers, management and suppliers of the at least one of the business units;
said supplying of data including supplying analysis of travel spending.

2. The method of claim 1, having the suppliers operate with different travel and protocols wherein said consolidating and supplying occurs substantially simultaneously.

3. The method of claim 1, wherein said supplying further includes data for travel issues.

4. The method of claim 1, wherein said supplying further includes data for contract/audit issues.

5. The method of claim 1, wherein consolidating from the sources include from one or more corporate card providers, travel agency service providers, and ancillary travel service providers.

6. The method of claim 5, wherein service providers include travel agency booking offices.

7. The method of claim 5, wherein corporate card providers include corporate card data sources.

8. The method of claim 5, wherein service providers include online booking sources.

9. The method of claim 5, wherein ancillary travel services include at least one of ground transportation services,
security specialists, and travel benchmarking information.

10. The method of claim 1, wherein said consolidating is done in real time, “real time” meaning “as the transaction occurs.”

11. The method of claim 10, wherein said supplying occurs on a real time basis.

12. The method of claim 1, wherein said supplying is performed through a display available to at least one of the business units.

13. The method of claim 1, wherein said supplying through a display is in easily manipulated formats.

14. The method of claim 1, wherein said supplying of consolidated data indicates the travelers who have deviated from the policy of the business unit.

15. The method of claim 1, wherein said supplying of consolidated data highlights pricing errors.

16. The method of claim 1, wherein said supplying of consolidated data indicates any traveler who has deviated from the planned itinerary of the traveler.

17. The method of claim 1, wherein said supplying of consolidated data automates the travel budget planning.

18. The method of claim 17, wherein said supplying of consolidated data identifies at least one of new destinations, pretravel approvals, policy exceptions of all travelers, real time tracking of expenditures, requirements for supplier contracts and analysis relative to the current travel, performance measurement, and individual information of a specific traveler.

19. The method of claim 1, wherein said supplying is performed through one or more computer networks formed by at least one business unit and at least some of the travelers, management and suppliers.

20. The method of claim 1, wherein said step of supplying includes the step of sorting the data.

21. The method of claim 20, wherein said step of supplying includes the step of aggregating the data.

22. The method of claim 1, wherein said step of supplying of the data includes determining rights to the data.

23. The method of claim 1, wherein there is included the step of calculating real time metrics from the data.

24. The method of claim 1, wherein there is further included the step of initiating transactions.

25. The method of claim 24, wherein said initiating of transactions originates from a display unit used for said step of supplying consolidated data.

26. The method of claim 1, wherein the suppliers include at least one of any GDSs, travel agencies, credit card companies, and alternate travel data sources.

27. A method for processing travel and credit card data for clients wishing to integrate travel and credit card information from one or more alternative Travel Agencies, GDS, Credit Card Companies, at least two alternative data systems provided by one or more travel providers having different travel and corporate card data information protocols comprising:
receiving information from each participating alternative GDS, Travel Agency, and Credit Card Company to allow receipt of their travel information in their native protocols;
converting travel and card information of each alternative GDS, Travel Agency, and Credit Card Company system into a uniform travel and card data information protocol;
integrating the travel and card information from each alternative GDS, Travel Agency, and Credit Card Company system data communications into a single data view;
distributing the resulting combined travel and card data to clients in the common travel and card information protocol; and
displaying said integrated travel and card data to clients.

28. The method of claim 27 wherein there is included the step of limiting the travel and card information supplied to any individual client to review information from only those alternative GDS, Travel Agency, Credit Card Company and Alternate Travel Data Sources systems of which the client is utilizing.

29. The method of claim 27 wherein
at least one electronic exchange, having its native travel and card information protocol, participates in; and
the participating electronic exchanges' travel and card information is integrated with the travel and card information of the alternative trading systems, including:
receiving information from each participating GDS, Travel Agency, and Credit Card Company via electronic exchange to allow receipt of its travel and card information in the electronic exchanges' native information protocol;
converting the travel and card information from said participating GDS, Travel Agency, and Credit Card Company into the common information protocol; and
integrating the travel and card information from the alternative trading system with the travel and card information from one or more GDS, Travel Agency, and Credit Card Company to make a combined travel and card data source.

30. The method of claim 29, including the step of converting back and forth between the individual alternative travel and card systems' electronic exchanges' protocol and a common travel and card placement protocol, thereby allowing clients to do one or more of book travel, follow pre-travel authorization procedures, approve policy exceptions, analyze vendor usage, ensure employee compliance with corporate policies, analyze traveler behavior, take offers, and receive confirmation of executions in any of the individual alternative Travel Agency, GDS, or Credit Card Company systems.

31. The data processing system of claim 29 wherein there is the step of data converting between the individual alternative travel and card systems and a common protocol thereby allowing clients to do one or more of place orders, book travel, approve travel, approve or disapprove policy exceptions, drive employee compliance with corporate travel policies, take offers, receive confirmation of execution, and have access to all the travel and card entry features of each participating alternate Travel Agency, GDS, and Credit Card Company systems.

32. The data processing system of claim 29 wherein there is included the step of filtering out travel and card booking and payment information by parameters selected by the client.

33. The method of claim 27 wherein there is included the step of converting back and forth between the individual alternative Travel Agency, GDS, and Credit Card Company systems' travel and card placement protocol and a common travel and card placement protocol, thereby allowing clients to do one or more of place book travel, purchased travel, refunded travel and other business travel items purchased via Corporate Credit Card into an analysis tool and, take offers, and receive confirmation of the final items purchased.

34. The method of claim 27 wherein there is included the step of organizing the travel and card booking and payment information by vendor, by location or sale, and then by one or more of price, volume, division, cost center, preferred and non-preferred vendors or as selected by the client.

35. A data processing method for providing integrated travel and card information to clients for use with travelers from two or more alternative Travel Agency, GDS, or Credit Card Company systems, comprising:
receiving travel and card booking information from each participating alternative Travel Agency, GDS, and Credit Card Company system in travel and card booking and payment information protocols native to the particular alternative Travel Agency, GDS, and Credit Card Company system;
converting the information to a common travel and card booking and payment data protocol;
integrating the travel and card booking and payment information from each alternative Travel Agency, GDS, and Credit Card Company system into a single travel and card management application;
distributing the combined travel and card booking and payment data to the clients in the TravelMaster travel and card booking payment protocol; and
displaying said combined travel and card booking and payment data to the clients and travelers.

36. The method of claim 35 wherein there is included the step of limiting the travel and card booking and payment information to any client to only those alternative Travel Agency, GDS, and Credit Card Company systems to which the client is a member.

37. The method of claim 35 wherein there is included the step of integrating the travel and card booking and payment of the alternative Travel Agency, GDS, and Credit Card Company with information from one or more electronic data sources (ATDS).

38. The method of claim 37 wherein there is included the step of supplying travel and card booking and payment information from one or more electronic formats in their native travel and card information protocol that is converted to the common protocol and integrating into the combined travel and card booking and payment information data set.

39. The method of claim 37 wherein there is the step of filtering the travel booking and card payment information by parameters selected by the client.

40. The method of claim 35 wherein after the step of integrating there is the step of filtering by vendor, and by one or more of location or sale, and by one or more of price, or volume as selected by the client.

41. The method of claim 35 wherein there is included the step of automatically controlling the policies and management of travel and cards with the analysis information.

42. The method of claim 35 wherein the client books travel, makes card payments, takes offers, and receives confirmation of execution in a common travel and card placement protocol.
